(19) United States
(12) Patent Application Publication
(10) Pub. No.: US 2025/0234365 A1
(43) Pub. Date: Jul. 17, 2025

(54) MANAGING HYBRID AUTOMATIC REPEAT REQUEST TRANSMISSION FOR MULTICAST AND/OR BROADCAST SERVICES

(71) Applicant: GOOGLE LLC, Mountain View, CA (US)

(72) Inventors: Chih-Hsiang Wu, Taoyuan City (TW); Kao-Peng Chou, Taoyuan City (TW)

(21) Appl. No.: 18/727,831

(22) PCT Filed: Jan. 6, 2023
(86) PCT No.: PCT/US2023/010310

§ 371 Date: Jul. 10, 2024

(51) Int. Cl. H04W 72/30

(52) U.S. Cl. CPC H04W 72/30

(57) ABSTRACT

A user equipment (UE) for receiving multicast and/or broadcast service (MBS) (i) attempts to receive (902), from a base station via multicast, a first transmission that includes an MBS data packet associated with the MBS, (ii) transmits (904), to the base station, an indication of whether the UE successfully received the first transmission, in accordance with a mechanism for automatic retransmission of undelivered packets, (iii) in response to the transmitting, attempts to receive (906), from the base station via unicast, a second transmission in accordance with the mechanism, and (iv) determines (908) whether the second transmission is a new transmission or a retransmission of the first transmission.

### CROSS-REFERENCE TO RELATED APPLICATIONS

This application claims the benefit of U.S. Provisional Application No. 63/297,897, filed Jan. 10, 2022 and entitled “Managing Hybrid Automatic Repeat Request Transmission for Multicast and/or Broadcast Services,” which is hereby incorporated herein by reference in its entirety.

### FIELD OF THE DISCLOSURE

This disclosure relates to wireless communications and, more particularly, to enabling automatic retransmission of undelivered packets, such as Hybrid Automatic Repeat Request (HARQ), for one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface. On the other hand, in PTM communications, a RAN node transmits a single copy of each MBS data packet to multiple UEs over the radio interface. In some scenarios, however, it is unclear how a base station uses HARQ mechanisms to transmit MBS data to one or more UEs via PTM transmission (i.e., multicast) and/or PTP transmission (i.e., unicast).

### SUMMARY

Generally speaking, a base station (e.g., an integrated base station or a component of a distributed base station) and/or UE implement a mechanism for automatic retransmission of undelivered packets, such as HARQ, to improve reliability of MBS. A base station initially sends a first transmission including an MBS packet to the UE, and in response to feedback received from the UE for the first transmission, sends a subsequent second transmission to the UE. The base station can determine how (e.g., via multicast or unicast) to send the subsequent second transmission based on various factors. Such factors relate to whether the UE supports or enabled PTP retransmission, whether the first transmission was delivered via multicast or unicast, the type of feedback for the first transmission received from the UE, and network bandwidth conditions associated with the first transmission. The UE can determine whether the second transmission is a new transmission or a retransmission of the first transmission based on various factors related to whether the UE supports or enabled PTP retransmission, whether the first transmission and the second transmission have the same transport block size, and determining which RNTI was used to receive the second transmission.

One example embodiment of these techniques is a method implemented in a UE for receiving MBS. The method can be executed by processing hardware and includes attempting to receive, from a base station via multicast, a first transmission that includes an MBS data packet associated with the MBS; transmitting, to the base station, an indication of whether the UE successfully received the first transmission, in accordance with a mechanism for automatic retransmission of undelivered packets; in response to the transmitting, attempting to receive, from the base station via unicast, a second transmission in accordance with the mechanism; and determining whether the second transmission is a new transmission or a retransmission of the first transmission.

Another example embodiment of these techniques is a UE including processing hardware configured to execute the method above.

Yet another example embodiment of these techniques is a method in a base station for receiving MBS. The method can be executed by processing hardware and includes transmitting, to a plurality of UEs, a first transmission including an MBS data packet associated with the MBS, using a mechanism for automatic retransmission of undelivered packets; receiving, from at least one of the plurality of UEs, an indication of whether a UE successfully received the first transmission; and in response to the receiving, determining, by the processing hardware, whether to transmit a second transmission via multicast or unicast, in accordance with the mechanism.

Still another embodiment of these techniques is a base station including processing hardware configured to execute the method above.

### BRIEF DESCRIPTION OF THE DRAWINGS

FIG. 1A is a block diagram of an example system in which the techniques of this disclosure for managing multicast radio resources may be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram of an example tunnel architectures for MBS sessions and PDU sessions;

FIG. 4 is a block diagram of an example tunnel architectures for MRBs and DRBs;

FIG. 5A is a messaging diagram of an example scenario in which a CN and a base station of FIGS. 1A and/or 1B manage the transmission of downlink data for different MBS sessions joined by different UEs;

FIG. 5B is a messaging diagram of an example scenario similar to the scenario of FIG. 5A, but in which one of the UEs joins both the first and the second MBS session;

FIG. 6A is a flow diagram of an example method, which can be implemented in a UE of this disclosure, for performing a HARQ process when the UE does not support PTP retransmission;

FIG. 6B is a flow diagram of an example method, which can be implemented in a UE of this disclosure, for performing a HARQ process when the UE supports PTP retransmission.

FIG. 6C is a flow diagram of an example method, which can be implemented in a UE of this disclosure, for performing a HARQ process when the UE enables or disables PTP retransmission.

FIG. 6D is a flow diagram of an example method, which can be implemented in a UE of this disclosure, for performing a HARQ process that includes comparing transport block sizes of HARQ transmissions;

FIG. 6E is a flow diagram of an example method, which can be implemented in a UE of this disclosure, for performing a HARQ process using a C-RNTI or a G-RNTI to process a HARQ transmission;

FIG. 7A is a flow diagram of an example method, which can be implemented in a base station of this disclosure, for performing a HARQ process based on whether a UE supports PTP retransmission;

FIG. 7B is a flow diagram of an example method, which can be implemented in a base station of this disclosure, for performing a HARQ process based on whether a UE enabled PTP retransmission;

FIG. 7C is a flow diagram of an example method, which can be implemented in a base station of this disclosure, for performing a HARQ process in which a manner of sending a HARQ transmission to a UE controls how to send a subsequent HARQ transmission to the UE;

FIG. 8A is a flow diagram of an example method, which can be implemented in a base station of this disclosure, for performing a HARQ process in which the type of HARQ feedback received from a UE in response to a HARQ transmission determines how to send a subsequent HARQ transmission to the UE;

FIG. 8B is a flow diagram of an example method, which can be implemented in a base station of this disclosure, for performing a HARQ process in which network bandwidth considerations associated with a HARQ transmission determines how to send a subsequent HARQ transmission to the UE;

FIG. 9 is a flow diagram of an example method for receiving MBS, which can be implemented in a UE of FIG. 1A; and

FIG. 10 is a flow diagram of an example method for providing MBS, which can be implemented in a base station of FIG. 1A or FIG. 1B.

### DETAILED DESCRIPTION OF THE DRAWINGS

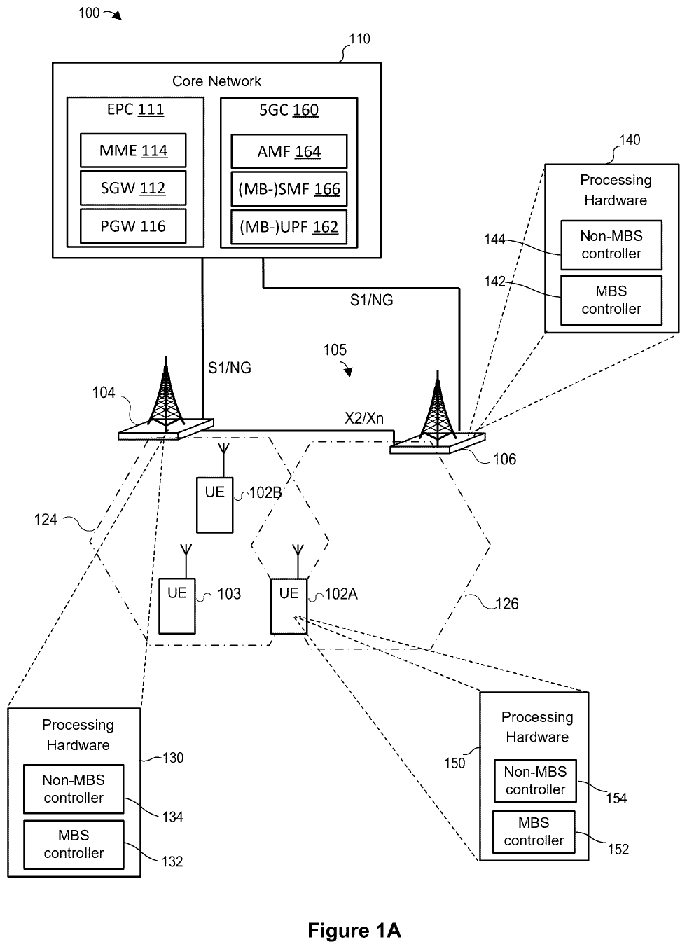

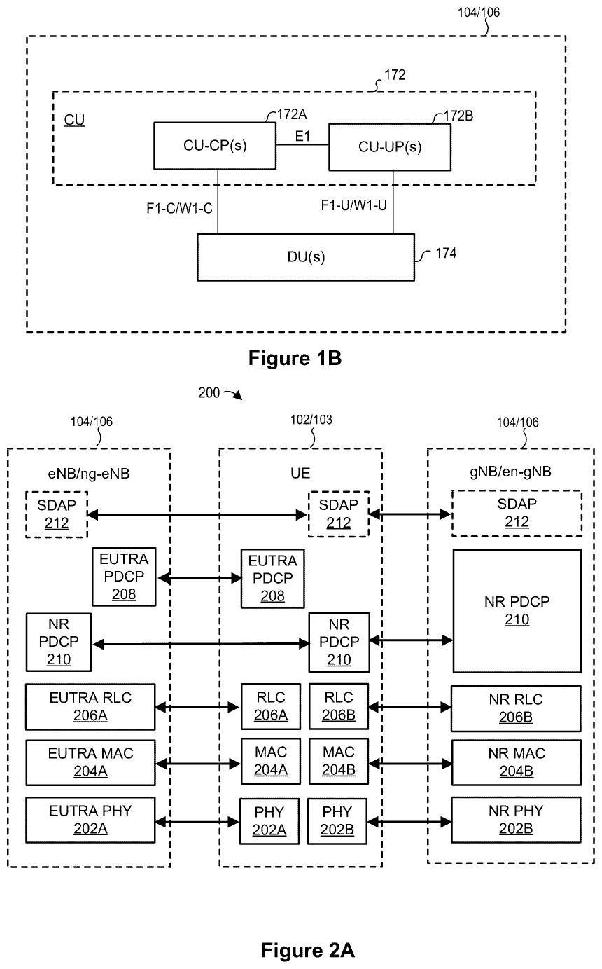

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, and 103 as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A, via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, including a HARQ process, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, including a HARQ process, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, UEs 102B and 103 may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

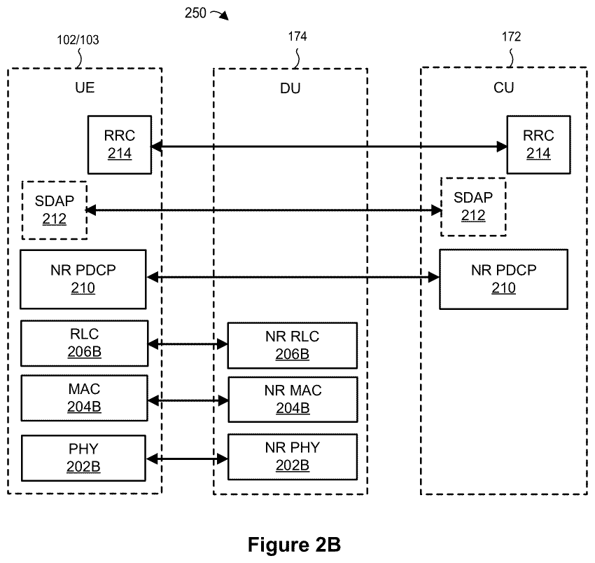

FIG. 2A illustrates, in a simplified manner, an example protocol stack 200 according to which a UE (e.g., UE 102A, 102B, or 103) can communicate with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A, 102B, or 103 operates in EN-DC with the base station 104 operating as an MeNB and the base station 106 operating as an SgNB, the wireless communication system 100 can provide the UE 102A, 102B, or 103 with an MN-terminated bearer that uses EUTRA PDCP sublayer 208, or an MN-terminated bearer that uses NR PDCP sublayer 210. The wireless communication system 100 in various scenarios can also provide the UE 102A, 102B, or 103 with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE 102A, 102B, or 103 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A uses PHY sublayer 202, MAC sublayer 204, and RLC sublayer 206 to receive the MBS data packets. In such implementations, the base station and the UE 102A, 102B, or 103 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A, 102B, or 103 uses PHY sublayer 202, MAC sublayer 204, RLC sublayer 206 and PDCP sublayer 208 to receive the MBS data packets. In such implementations, the base station and the UE 102A, 102B, or 103 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A, 102B, or 103 uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 that the UE 102A, 102B, or 103 can use to communicate with a DU (e.g., DU 174) and a CU (e.g., CU 172). The radio protocol stack 200 of FIG. 2A is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) can be delegated to the DU. To support connection to a 5GC, NR PDCP 210 provides SRBs to RRC 214, and NR PDCP 210 provides DRBs to SDAP 212 and SRBs to RRC 214.

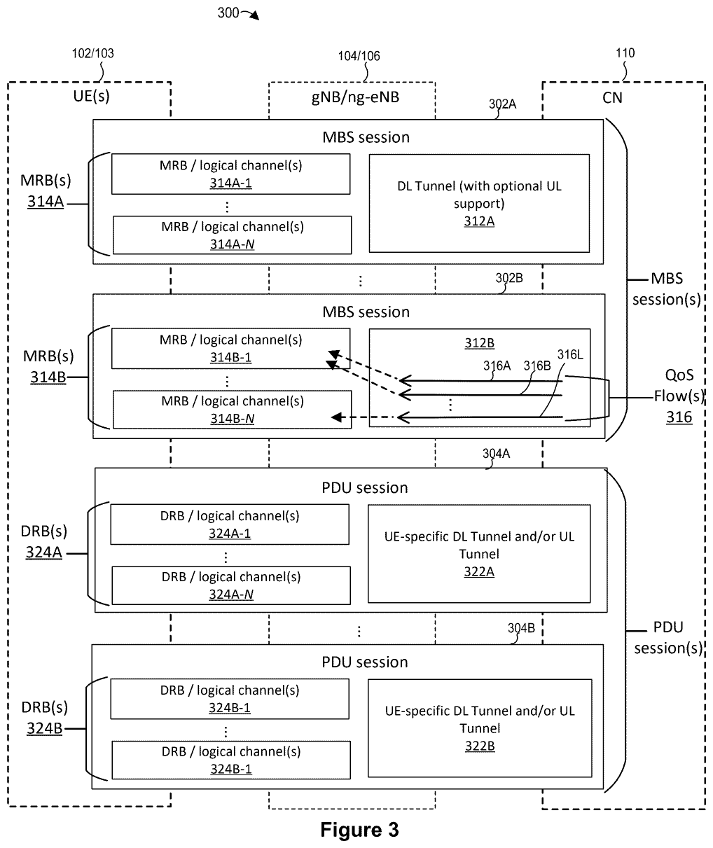

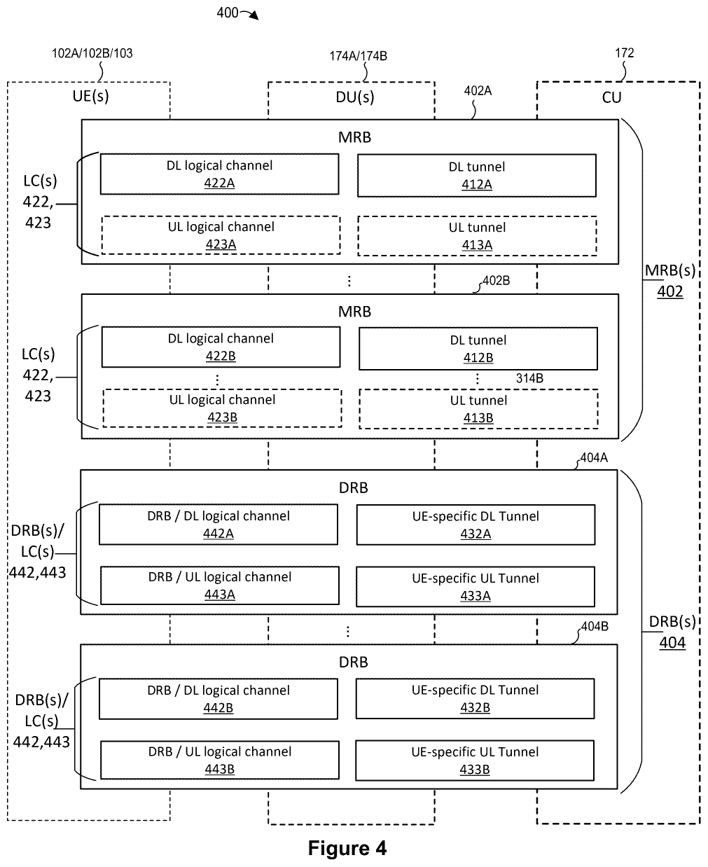

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet, and transmit the tunnel packet downstream to the base station 104/106 via the tunnel 312A (i.e., the header(s) can include the IP address and/or the TEID). For example, the header(s) can include an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QoS) flows, for each of the tunnels 312A, 312B, etc. For example, the MBS traffic on the tunnel 312B can include a set of flows 316 including QoS flows 316A, 316B, . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324-N. Each of the DRBs 324A can correspond to a respective logical channel, such as a Dedicated Traffic Channel (DTCH).

Now referring to FIG. 4, when the base station 104/106 is implemented in a distributed manner, the CU 172 and the DU 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU 174A/174B, and a DL logical channel 422A corresponding to the DL tunnel 412A. In particular, the DU 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU 174A/174B, and a UL logical channel 423A corresponding to the UL tunnel 413A. The UL logical channel 423A can be a DTCH, for example. The DU 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A. In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

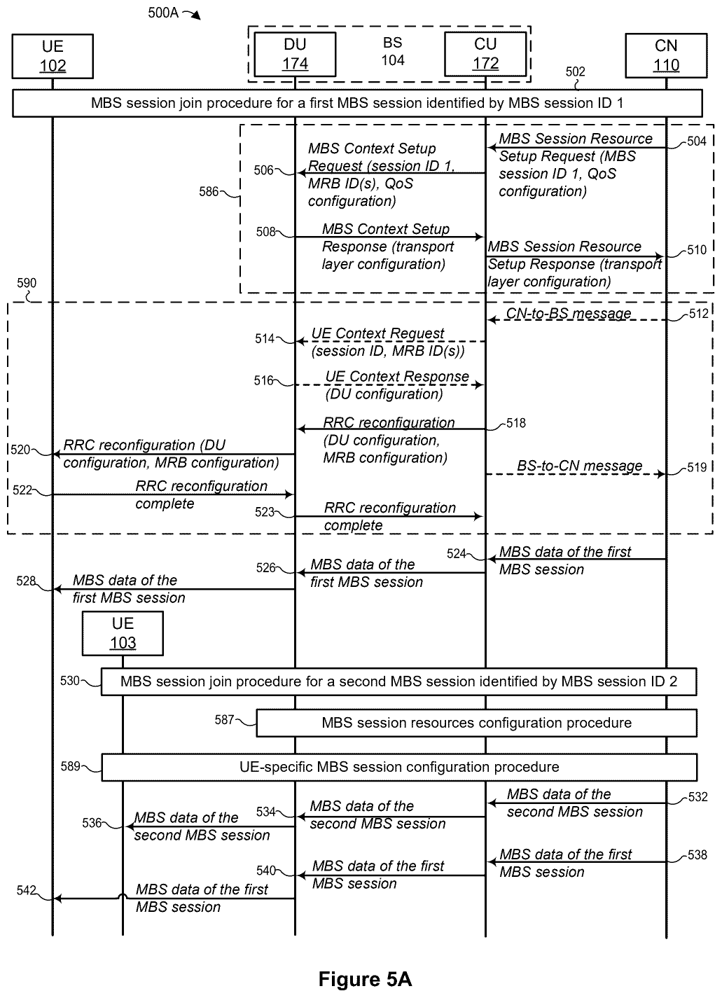

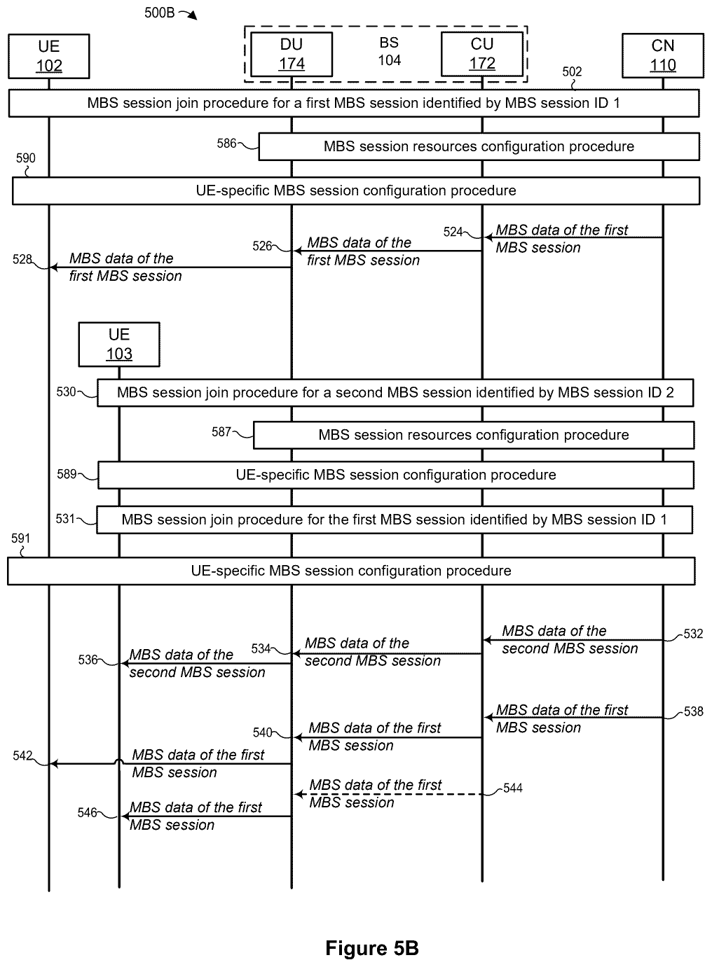

Next, FIG. 5A illustrates an example scenario 500A in which the base station 104 configures a first common tunnel for MBS data in response to the CN requesting resources for a first MBS session and configures a second common tunnel for MBS data in response to the CN requesting resources for a second MBS session.

The UE 102 (e.g., UE 102A of FIG. 1A) initially performs 502 an MBS session join procedure with the CN 110 via the base station 104 to join a first MBS session. In some scenarios, the UE 102 subsequently performs an additional one or more MBS join procedures, and event 502 accordingly is a first one of multiple MBS join procedures. Because the base station 104 configures a common DL tunnel for MBS traffic (rather than a UE-specific tunnel as discussed below), the procedures 502 and 586 can occur in either order. In other words, the base station 104 can configure a common DL tunnel before even a single UE joins the first MBS session.

To perform the MBS session join procedure, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID for the first MBS session in the MBS session join request message. The CN 110 in some cases includes the first MBS session ID in the MBS session join response message. In some implementations, the UE 102 can send an MBS session join complete message to the CN 110 via the base station 104 in response to the MBS session join response message.

The UE 102 in some cases performs additional MBS session join procedure(s) with the CN 110 via the RAN 105 (e.g., the base station 104 or base station 106) to join additional MBS session(s). For example, the UE 102 can perform a second MBS session join procedure with the CN 110 via the RAN 105 to join a second MBS session. Similar to event 502, the UE 102 in some implementations can send a second MBS session join request message to the CN 110 via the base station 104, and the CN 110 can respond with a second MBS session join response message to grant the UE 102 access to the second MBS session. In some implementations, the UE 102 can send a second MBS session join complete message to the CN 110 via the base station 104 in response to the second MBS session join response message. In some implementations, the UE 102 can include a second MBS session ID of the second MBS session in the second MBS session join request message. The CN 110 optionally includes the second MBS session ID in the second MBS session join response message. In some implementations, the UE 102 can include the first and second MBS session IDs in an MBS session join request message (e.g., the first MBS session join request message) to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response, and MBS session join complete message can be a PDU Session Modification Request message, a PDU Session Modification Command message, and a PDU Session Modification Complete message, respectively. To simplify the following description, the terms MBS session join request message, MBS session join response message, and/or MBS session join complete message can represent either the respective container messages, or the respective messages without containers.

In some implementations, the UE 102 can perform a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

Before, during, or after the first MBS session join procedure (event 502), the CN 110 can send 504 a (first) CN-to-BS message including the first MBS session ID and/or PDU session ID to the CU 172 to request the CU 172 to configure resources for the first MBS session. The CN 110 can additionally include quality of service (QoS) configuration(s) for the first MBS session in the first CN-to-BS message. In response to receiving 504 the first CN-to-BS message, the CU 172 sends 506 a CU-to-DU message (e.g., an MBS Context Setup Request message) to the DU 174 to request a set-up for an MBS context and/or a common DL tunnel for the first MBS session. The MBS Context Setup Request message may include the first MBS session ID, MRB ID(s), and QoS configuration(s) for the first MBS session.

In response to receiving 506 the CU-to-DU message, the DU 174 sends 508, to the CU, a DU-to-CU message (e.g., an MBS Context Setup Response message) including a first DL transport layer configuration to configure a common CU-to-DU DL tunnel for the first MBS session (e.g., for an MRB identified by one of the MRB ID(s)). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message of event 506 is a generic F1AP message or a dedicated F1AP message defined specifically to convey this type of a request (e.g., an MBS Context Setup Request message). In some implementations, the DU-to-CU message of event 508 is a generic F1AP message or a dedicated F1AP message defined specifically for this purpose (e.g., an MBS Context Setup Response message). The CN 110 can additionally include quality of service (QoS) configuration(s) for the first MBS session. In such cases, the CU 172 can include the QoS configuration(s) in the CU-to-DU message (event 506).

The CU 172 can then send 510 a first BS-to-CN message (e.g., an MBS Session Resource Setup Response message) including the DL transport layer configuration to configure the common DL tunnel. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer address (e.g., an IP address and/or a TEID) to identify the common DL tunnel.

In some implementations, the CN-to-BS message of event 504 can be a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the first MBS session. In some implementations, the QoS configuration includes configuration parameters to configure one or more QoS flows for the MBS session (e.g., MBS session 302A of FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume, for example. The CN 110 can specify different values of the QoS parameters for the QoS flows.

The events 504, 506, 508, and 510 are collectively referred to in FIGS. 5A and 5B as an MBS session resource setup procedure 586.

In cases where the CN 110 grants the additional MBS session(s) for the UE 102 in the additional MBS session join procedure(s), the CN 110 can include the additional MBS session ID(s) and/or QoS configuration(s) for the additional MBS session ID(s) in the first CN-to-BS message, the second CN-to-BS message (discussed below in connection with event 512), or additional CN-to-BS message(s) similar to the first or second CN-to-BS message. In such cases, the CU 172 includes additional transport layer configuration(s) for the additional MBS session(s) to configure additional common DL tunnel(s) in the first BS-to-CN message, the second BS-to-CN message (discussed below in connection with event 519), or additional BS-to-CN message(s) similar to the first or second BS-to-CN message. Each of the transport layer configuration(s) configures a particular DL tunnel of the common DL tunnel(s) and can be associated to a particular MBS session of the additional MBS session(s). Alternatively, the CN 110 can perform additional MBS session resource setup procedure(s) with the CU 172 to obtain the additional transport layer configuration(s) from the CU 172, similar to the single-session MBS session resource setup procedure 586. The transport layer configurations can be different to distinguish between different common DL tunnels. In particular, any pair of the transport layer configurations can have different IP addresses, different DL TEIDs, or both different IP addresses and different DL TEIDs.

In some implementations, the CN 110 can indicate, in the CN-to-BS message of event 504, a list of UEs joining the first MBS session. In other implementations, the CN 110 can send 512 to the CU 172 another, second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message of event 512. In such cases, the second CN-to-BS message can be a non-UE-specific message, i.e., a message not specific for the UE 102A or the UE 102B. The CU 172 can include the first MBS session ID and/or the PDU session ID in the second BS-to-CN message. For example, the list of UEs includes the UE 102. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends the list of (CN UE interface ID, RAN UE interface ID) pairs, the CU 172 sends a BS-to-CN message (e.g., a NGAP message, an INITIAL UE MESSAGE or PATH SWITCH REQUEST message) including the RAN UE interface ID to the CN 110 for each of the UEs, and the CN 110 sends a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair (a first CN UE interface ID and a first RAN UE interface ID) identifying the UE 102. In some implementations, the “CN UE interface ID” can be a “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends the list of UE IDs, the CU 172 can receive the UE ID from the UE 102 or the CN 110 for each of the UEs. For example, the CU 172 can receive an RRC message (e.g., an RRCSetupComplete message) including the UE ID from the UE 102 during an RRC connection establishment procedure. In another example, the CU 172 can receive a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) that the UE 102 joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102A to receive MBS data of the first MBS session. In some implementations, the CU 172 can include the QoS configuration(s) in the UE Context Request message. In such cases, the CU 172 may or may not include the QoS configuration(s) in the CU-to-DU message. Some or all of the configuration parameters may be associated to the MRB(s)/MRB ID(s). In some implementations, the DU 174 generates a DU configuration (i.e., a first DU configuration) to include the configuration parameters (i.e., first plural configuration parameters) and includes the DU configuration in the UE Context Response message. In some implementations, the DU configuration can be a CellGroupConfig IE. In other implementations, the DU configuration can be an MBS-specific IE. In some implementations, the configuration parameters configure one or more logical channels (LCs). For example, the configuration parameters include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively. In some implementations, the second CN-to-BS message and the second BS-to-CN message can be UE-associated messages, i.e., the messages are associated to a particular UE (e.g., the UE 102A, 102B, or 103).

In some implementations, the CU 172 transmits 510 the first BS-to-CN message in response to event 512, and not in response to event 504 as shown in FIG. 5A. Then, the CN 110 can send a CN-to-BS response message to the CU 172 in response to the first BS-to-CN message. In such cases, the CU 172 can transmit 506 the CU-to-DU message to the DU 174 in response to receiving the second CN-to-BS message, and the first BS-to-CN message and the CN-to-BS response message can be non-UE associated messages (i.e., the messages are not associated to a particular UE).

In some implementations, the DU 174 transmits 508 the DU-to-CU message in response to event 514 (rather than in response to event 506), in addition to transmitting 516 the UE Context Response message in response to event 514. Then, the CU 172 can send a CU-to-DU response message to the DU 174 in response to the DU-to-CU message. In such cases, the DU-to-CU message and the CU-to-DU response message can be non-UE associated messages, i.e., the messages are not associated to a particular UE.

In cases where the CN 110 grants the additional MBS session(s) for the UE 102 in the additional MBS session join procedure(s), the CN 110 can include the additional MBS session ID(s) and/or QoS configuration(s) for the additional MBS session ID(s) in the first CN-to-BS message or the second CN-to-BS message. In such cases, the CU 172 can include the additional MBS session ID(s) and additional MRB ID(s) in the CU-to-DU message, and the DU 174 can include, in the DU-to-CU message, additional DU transport layer configuration(s) to configure additional CU-to-DU DL tunnel(s) for the additional MBS session(s). Alternatively, the CU 172 can perform additional MBS context setup procedure(s) with the DU 174 to obtain the additional DU DL transport layer configuration(s), similar to the events 506 and 508. In some implementations, the CU 172 includes, in the first BS-to-CN message, additional CU DL transport layer configuration(s) for the additional MBS session(s) to configure additional CN-to-BS common DL tunnel(s). Each of the transport layer configuration(s) configures a particular DL tunnel of the common CN-to-BS DL tunnel(s) and can be associated to a particular MBS session of the additional MBS session(s). Alternatively, the CN 110 can perform additional MBS session resource setup procedure(s) with the CU 172 to obtain the additional CU DL transport layer configuration(s) from the CU 172, similar to the MBS session resource setup procedure 586. The transport layer configurations can be different to distinguish between different common DL tunnels. In particular, any pair of the transport layer configurations can have different IP addresses, different DL TEIDs, or both different IP addresses and different DL TEIDs.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the first MBS session in response receiving the CU-to-DU message or the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) in neither the CU-to-DU message nor the UE Context Request message, the DU 174 can determine values of the configuration parameters in accordance with a predetermined QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations (i.e., first MRB configuration(s)) and transmits 518 the RRC reconfiguration message to the DU 174. In turn, the DU 174 transmits 520 the RRC reconfiguration message to the UE 102. The UE 102 then transmits 522 an RRC reconfiguration complete message to the DU 174, which in turn transmits 523 the RRC reconfiguration complete message to the CU 172. The events 512, 514, 516, 518, 519 (discussed below), 520, 522, and 523 are collectively referred to in FIGS. 5A and 5B as a UE-specific MBS session configuration procedure 590.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B and PHY layer 202B. The UE 102 receives 520 the PDCP PDU from the DU 174 via the PHY layer 202B, MAC layer 204B, and RLC layer 206B. In some implementations, the UE 102 generates a PDCP PDU including the RRC reconfiguration complete message and transmits 522 the PDCP PDU to the DU 174 via the RLC layer 206B, MAC layer 204B, and PHY layer 202B. The DU 174 receives 522 the PDCP PDU from the UE 102 via the PHY layer 202B, MAC layer 204B, and RLC layer 206B, and sends 523 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

In some implementations, the CU 172 includes the CU DL transport layer configuration(s) in the second BS-to-CN message and/or the additional BS-to-CN message. In other words, the CU 172 can send the same CU DL transport layer configuration(s) in BS-to-CN messages in responses to CN-to-BS messages indicating UEs joining the same MBS session. In such implementations, the CN 110 can blend the MBS resource setup procedure 586 and the second CN-to-BS and BS-to-CN messages into a single procedure.

In cases where the CU 172 performs the MBS resource setup procedure 586 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

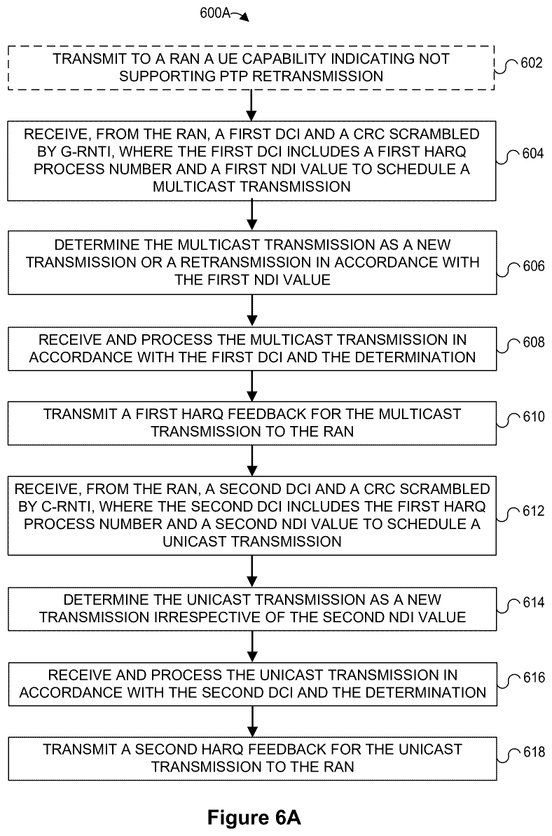

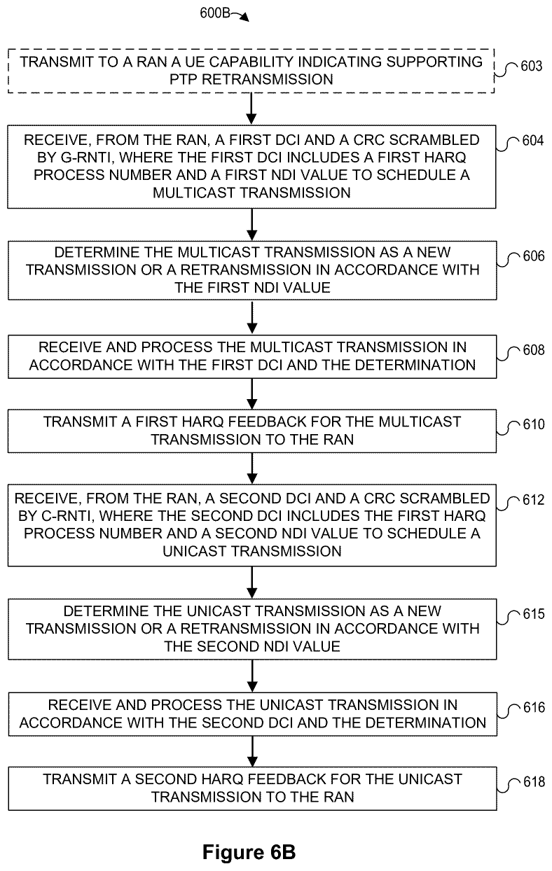

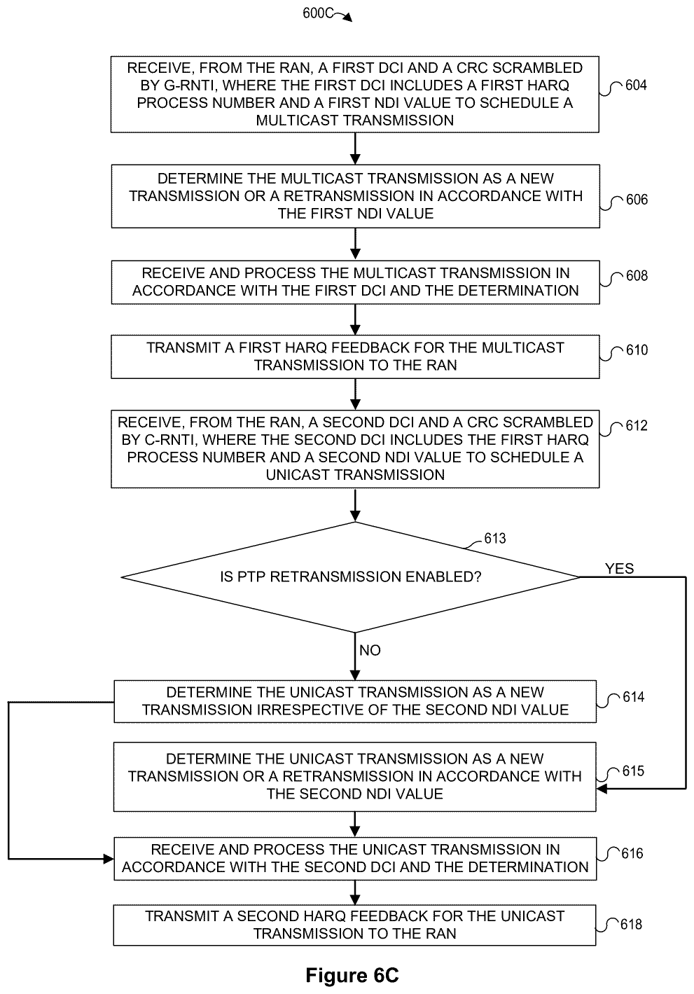

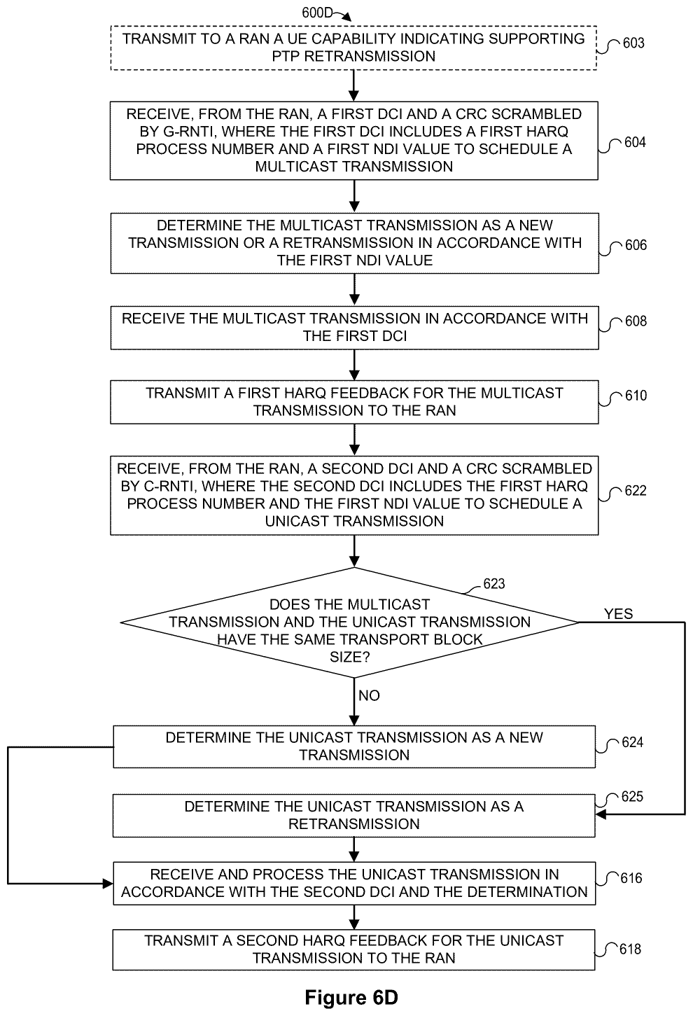

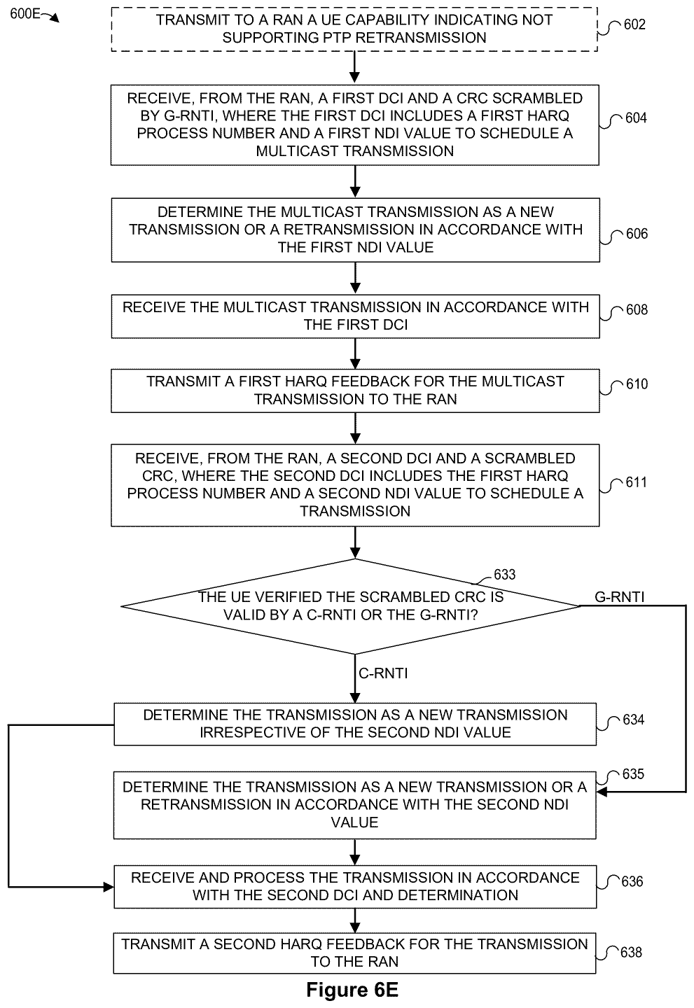

After receiving 510 the first BS-to-CN message or 519 the second BS-to-CN message, the CN 110 can send 524 MBS data (e.g., one or multiple MBS data packets) for the first MBS session to the CU 172 via the common CN-to-BS DL tunnel, and the CU 172 in turn sends 526 the MBS data to the DU 174 via the common CU-to-DU tunnel. The DU 174 transmits (e.g., multicast or unicast) 528 the MBS data via the one or more logical channels to the UE 102. The UE 102 receives 528 the MBS data via the one or more logical channels. For example, the CU 172 may receive 524 an MBS data packet, generate a PDCP PDU including the MBS data packet, and transmit 528 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration. In some implementations, the DU 174 can transmit 528 the MBS data or the MAC PDU via one or more multicast transmissions (e.g., dynamic or SPS multicast transmission(s)) to the UE 102 as described above. In such cases, the UE 102 can receive 528 the MBS data or the MAC PDU via the one or more multicast transmissions from the DU 174 as described above. As will be described further below in FIGS. 6A-6E, 7A-7C, and 8A-8B, the UE 102 can receive 528 the MBS data or the MAC PDU using a HARQ process, in which the UE 102 sends HARQ feedback to the base station 104 (e.g., DU 174) to indicate whether the UE successfully received the MBS data (e.g., a first MBS data packet). Based on the HARQ feedback, the base station 104 (e.g., DU 174) transmits 528 the MBS data, either as a retransmission (e.g., the first MBS data packet) or a new transmission (e.g., a second MBS data packet).

In some implementations, the CU 172 can determine to configure, and configure, a UE-specific CN-to-BS DL tunnel for the UE 102 in response to receiving the first or second CN-to-BS message. In such cases, the CU 172 can omit the event 506, and can include, in the second BS-to-CN message, a DL transport layer configuration configuring a UE-specific DL tunnel. The CN 110 can transmit 524 the MBS data to the CU 172 via the UE-specific CN-to-BS DL tunnel. In some implementations, the CU 172 can determine to configure, and configure, a UE-specific CU-to-DU DL tunnel for the UE 102 in response to receiving the first or second CN-to-BS message. In such cases, the CU 172 can omit the event 510 and the DU 174 can include, in the UE Context Response message, a DL transport layer configuration configuring a UE-specific CU-to-DU DL tunnel. In such cases, the CU 174 can transmit 526 the MBS data to the DU 174 via the UE-specific CU-to-DU DL tunnel.

In some implementations, the configuration parameters can also include one or more RLC bearer configurations, each associated with a particular MRB. Each of the MRB configuration(s) can include an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include a logical channel configuration (e.g., LogicalChannelConfig IE) configuring the logical channel. In some implementations, the RLC bearer configuration may include the MRB ID.

In some implementations, the CU 172 can configure the MRB as a DL-only RB in the MRB configuration. For example, the CU 172 can refrain from including UL configuration parameters in the PDCP configuration within the MRB configuration to configure the MRB as a DL-only RB. The CU 172 can include only DL configuration parameters in the MRB configuration, e.g., as described above. In such cases, the CU 172 configures the UE 102 to not transmit UL PDCP data PDU via the MRB to the DU 174 and/or the CU 172 by excluding the UL configuration parameters for the MRB in the PDCP configuration in the MRB configuration. In another example, the DU 174 refrains from including UL configuration parameters in the RLC bearer configuration. In such cases, the DU 174 configures the UE 102 not to transmit the control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de) compression protocol (e.g., robust header compression (ROHC) protocol). In this case, when the CU 172 receives 524 an MBS data packet from the CN 110, the CU 172 compresses the MBS data packet with the compression protocol to obtain compressed MBS data packet(s) and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet(s) with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). An MRB ID identifies a particular MRB of the MRB(s). The base station 104 sets the MRB IDs to different values. In cases where the CU 172 has configured DRB(s) to the UE 102 for unicast data communication, the CU 172 in some implementations can set one or more of the MRB ID(s) to values different from DRB ID(s) of the DRB(s). In such cases, the UE 102 and the CU 172 can distinguish whether an RB is an MRB or DRB in accordance an RB ID of the RB. In other implementations, the CU 172 can set one or more of the MRB ID(s) to values which can be the same as the DRB ID(s). In such cases, the UE 102 and the CU 172 can distinguish whether an RB is an MRB or DRB in accordance an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU 172 can determine an RB is a DRB if the CU 172 transmits a DRB-ToAddMod IE configuring the RB to the UE 102, and determine an RB is an MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)).

In some implementations, the configuration parameters can include dynamic scheduling multicast configuration parameter(s) for the UE 102 to receive multicast transmissions each including MBS data or a particular portion of MBS data. In some implementations, the dynamic scheduling multicast configuration parameter(s) can include at least one of the following configuration parameters:
Group radio network temporary identifier (G-RNTI). The DU 174 dynamically schedules each multicast transmission, including a particular MAC PDU, for the UE 102 by generating a DCI, scrambling a cyclic redundancy check (CRC) of the DCI with the G-RNTI, and transmitting the DCI and the scrambled CRC on a PDCCH. The MAC PDU can include an MBS data packet or a portion of an MBS data packet. The UE 102 receives the DCI and scrambled CRC on the PDCCH and verifies the scrambled CRC with the G-RNTI. For each multicast transmission, after the UE 102 verifies the (scrambled) CRC is valid, the UE 102 receives the multicast transmission in accordance with the corresponding DCI and retrieves the particular MAC PDU from the multicast transmission. In this case, each multicast transmission is a dynamic scheduling multicast transmission used in the following description. In some implementations, each DCI includes configuration parameters configuring a dynamic scheduling multicast radio resource scheduling the corresponding multicast transmission. In some implementations, the configuration parameters can include at least one of the following parameters. The configuration parameters of the each DCI can include the same values and/or different values for the following configuration parameters.
   Frequency domain resource assignment
   Time domain resource assignment
   Virtual resource block (VRB)-to-physical resource block (PRB) mapping
   Modulation and coding scheme (MCS)
   New data indicator
   Redundancy version
   HARQ process number
   Downlink assignment index
   PUCCH resource indicator
HARQ codebook (ID), which indicates a HARQ acknowledgement (ACK) codebook index for a corresponding HARQ ACK codebook for a dynamic scheduling multicast transmission received by the UE 102. The DU 174 uses the HARQ codebook (ID) to receive a HARQ ACK. In cases where the configuration parameters do not include the HARQ codebook (ID), the UE 102 and DU 174 may use a HARQ codebook (ID) for unicast transmission. In some implementations, the UE 102 can receive the HARQ codebook (ID) for unicast transmission in the DU configuration from the DU 174. In other implementations, the UE 102 can receive the HARQ codebook (ID) for unicast transmission in another DU configuration from the DU 174, similar to events 516, 518 and 520.
PUCCH resource configuration, which indicates a HARQ resource on a PUCCH where the UE 102 transmits a HARQ feedback (e.g., HARQ ACK and/or negative ACK (NACK)) for a dynamic scheduling multicast transmission. In cases where the configuration parameters do not include the PUCCH resource configuration, the UE 102 and DU 174 can use a PUCCH resource configuration for unicast transmissions to communicate HARQ feedback.
HARQ NACK only indication, which configures the UE 102 to only transmit a HARQ negative ACK (NACK) for a dynamic scheduling multicast transmission that the UE 102 receives from the DU 174 and from which the UE 102 fails to obtain a transport block. In some implementations, the UE 102 fails to obtain the transport block because the UE 102 fails a cyclic redundancy check (CRC) for the transport block or the UE 102 does not receive the dynamic scheduling multicast transmission. In accordance with the indication, the UE 102 refrains from transmitting to the DU 174 a HARQ ACK for a dynamic scheduling multicast transmission that the UE 102 successfully receives and from which the UE 102 obtains a transport block. In cases where the configuration parameters do not include the indication, the UE 102 can transmit to the DU 174 a HARQ ACK for a dynamic scheduling multicast transmission that the UE 102 successfully receives and from which the UE 102 obtains a transport block.
HARQ ACK/NACK indication, which configures the UE 102 to transmit a HARQ NACK for a dynamic scheduling multicast transmission where the UE 102 fails to obtain a transport block and configures the UE 102 to transmit a HARQ ACK for a dynamic scheduling multicast transmission that the UE 102 successfully receives and from which the UE 102 obtains a transport block. In cases where the configuration parameters do not include the indication, the UE 102 refrains from transmitting to the DU 174 a HARQ ACK for a dynamic scheduling multicast transmission that the UE 102 successfully receives and from which the UE 102 obtains a transport block. In such cases, the UE 102 is only allowed to transmit to the DU 174 a HARQ NACK for a dynamic scheduling multicast transmission where the UE 102 fails to obtain a transport block.
HARQ ACK indication, which configures the UE 102 to transmit a HARQ ACK for a dynamic scheduling multicast transmission that the UE 102 successfully receives and from which the UE 102 obtains a transport block. In cases where the configuration parameters do not include the indication, the UE 102 refrains from transmitting to the DU 174 a HARQ ACK for a dynamic scheduling multicast transmission where the UE 102 successfully obtains a transport block. In such cases, the UE 102 is only allowed to transmit to the DU 174 a HARQ NACK for a dynamic scheduling multicast transmission where the UE 102 fails to obtain a transport block. In some implementations, the DU 174 can include either one of the HARQ NACK indication, HARQ ACK/NACK indication and HARQ ACK indication.
Modulation and coding scheme (MCS) configuration, which indicates a MCS table that the DU 174 uses to transmit dynamic scheduling multicast transmissions and the UE 102 uses to receive dynamic scheduling multicast transmissions. For example, the MCS table can be a MCS table defined in 3GPP specification 38.214 (e.g., a low-SE 64QAM table indicated in Table 5.1.3.1-3 of 3GPP TS 38.214 or a new table specific for multicast transmission). In some implementations, if DU 174 does not include the MCS configuration in the DU configuration, the UE 102 and DU 174 can apply a MCS table predefined in 3GPP specification 38.214. For example, the predefined MCS table can be a 256QAM table or a 64QAM table, e.g., indicated in Table 5.1.3.1-2 or non-low-SE 64QAM table indicated in Table 5.1.3.1-1 of the specification 38.214, respectively. In cases where the DU 174 does not include the MCS configuration in the DU configuration, the UE 102 and DU 174 can apply a MCS table for unicast transmission to receive dynamic scheduling multicast transmissions from the DU 174. In some implementations, the DU 174 can include, in the DU configuration, a PDSCH configuration (e.g., PDSCH-Config) configuring the MCS table for unicast transmissions. In other implementations, the DU 174 can transmit to the UE 102 another DU configuration including the PDSCH configuration, similar to events 516, 518, and 520.
Aggregation factor, which is the number of repetitions for dynamic scheduling multicast transmission(s). The DU 174 can transmit (i.e., multicast) a number of repetitions of a dynamic scheduling multicast transmission in accordance the aggregation factor, and the UE 102 receives the repetitions based on the aggregation factor. In cases where the DU 174 does not include the aggregation factor in the DU configuration, the UE 102 in some implementations can apply an aggregation factor for unicast transmission(s). In some implementations, the DU 174 can include the aggregation factor for unicast transmission(s) to the UE 102 in the DU configuration. In other implementations, the DU 174 can transmit another DU configuration including the aggregation factor for unicast transmissions to the UE 102, similar to events 516, 518, and 520.

The RRC reconfiguration messages for UEs joining the first MBS session, include the same configuration parameters for receiving MBS data of the first MBS session. In some implementations, the RRC reconfiguration messages for the UEs may include the same or different configuration parameters for receiving non-MBS data.

In some implementations, the configuration parameters can include at least one semi-persistent scheduling (SPS) multicast configuration for the UE 102 to receive MBS data. Each of the at least one SPS multicast configuration can include at least one of the following parameters for SPS multicast transmissions.
Group configured scheduling radio network temporary identifier (G-CS-RNTI), which is used to activate or release an SPS multicast radio resource. The DU 174 can activate an SPS multicast radio resource for the UE 102 by generating an SPS multicast radio resource activation command (i.e., a DCI), scrambling a CRC of the DCI with the G-CS-RNTI, and transmitting the DCI and the scrambled CRC on a PDCCH. After activating the SPS multicast radio resource, the DU 174 periodically transmits a multicast transmission on the SPS multicast radio resource in accordance with the DCI. The UE 102 receives the DCI and scrambled CRC on the PDCCH and verifies the scrambled CRC with the G-CS-RNTI. After the UE 102 verifies the (scrambled) CRC is valid, the UE 102 activates (receiving on) the SPS multicast radio resource in response to the DCI and periodically receives a multicast transmission on the SPS multicast radio resource in accordance with the SPS multicast radio resource activation command (i.e., DCI) before the UE 102 deactivates the SPS multicast radio resource. In this case, the multicast transmission is an SPS multicast transmission used in the following description. In some implementations, the DU 174 can deactivate (or release) the SPS multicast radio resource by generating an SPS multicast radio resource deactivation command (i.e., a DCI), scrambling a CRC of the DCI with the G-CS-RNTI, and transmitting the DCI and the scrambled CRC on a PDCCH. The UE 102 receives the DCI and scrambled CRC on the PDCCH and verifies the scrambled CRC with the G-CS-RNTI. After the UE 102 verifies the (scrambled) CRC is valid, the UE 102 deactivates the SPS multicast radio resource, i.e., stops receiving on the SPS multicast radio resource. Each of the SPS multicast transmissions includes a particular MAC PDU which can include an MBS data packet or a portion of an MBS data packet. In some implementations, the SPS multicast radio resource activation command (i.e., DCI) includes configuration parameters configuring the SPS multicast radio resource. In some implementations, the configuration parameters can include at least one of the following parameters.
   Frequency domain resource assignment
   Time domain resource assignment
   Virtual resource block (VRB)-to-physical resource block (PRB) mapping
   Modulation and coding scheme (MCS)
   New data indicator
   Redundancy version
   HARQ process number
   Downlink assignment index
   PUCCH resource indicator
Periodicity, which indicates a periodicity of the SPS multicast radio resource.
Number of HARQ processes, which indicates a number of HARQ processes for communicating SPS multicast transmissions. The DU 174 uses at most the number of HARQ processes to transmit SPS multicast transmissions, and the UE 102 uses at most the number of HARQ processes to receive the SPS multicast transmissions.
HARQ codebook ID, which indicates a HARQ ACK codebook index for a corresponding HARQ ACK codebook for an SPS multicast transmission or an SPS multicast radio resource deactivation command received by the UE 102. In cases where the configuration parameters do not include the HARQ codebook (ID), the UE 102 may use a HARQ codebook (ID) for dynamic scheduling multicast transmission as described above. Alternatively, the UE 102 may use a HARQ codebook (ID) for unicast transmission. In some implementations, the UE 102 can receive the HARQ codebook (ID) for unicast transmission in the DU configuration from the DU 174 as described above.
HARQ process ID offset, which indicates an offset used in deriving HARQ process IDs for the DU 174 to transmit SPS multicast transmissions and for the UE 102 to receive SPS multicast transmissions.
PUCCH resource configuration for SPS multicast transmission, which indicates a HARQ resource on a PUCCH where the UE 102 transmits HARQ feedback (e.g., HARQ ACK and/or negative ACK (NACK)) for an SPS multicast transmission. In cases where the configuration parameters do not include the PUCCH resource configuration for SPS multicast transmission, the UE 102 and DU 174 can use a PUCCH resource configuration for dynamic scheduling multicast transmission to communicate a HARQ feedback as described above. Alternatively, the UE 102 can use a PUCCH resource configuration for unicast transmissions. In some implementations, the UE 102 can use the PUCCH resource configuration for unicast transmissions as described above.
HARQ NACK only indication, which configures the UE 102 to only transmit a HARQ negative ACK (NACK) for an SPS multicast transmission that the UE 102 receives from the DU 174 and from which the UE 102 fails to obtain a transport block. In some implementations, the UE 102 fails to obtain the transport block because the UE 102 fails a cyclic redundancy check (CRC) for the transport block or the UE 102 does not receive the dynamic scheduling multicast transmission. In accordance with the indication, the UE 102 refrains from transmitting to the DU 174 a HARQ ACK for an SPS multicast transmission that the UE 102 successfully receives and from which the UE 102 obtains a transport block. In cases where the configuration parameters do not include the indication, the UE 102 can transmit to the DU 174 a HARQ ACK for an SPS multicast transmission that the UE 102 successfully receives and from which the UE 102 obtains a transport block.
HARQ ACK/NACK indication, which configures the UE 102 to transmit a HARQ NACK for an SPS multicast transmission where the UE 102 fails to obtain a transport block and configures the UE 102 to transmit a HARQ ACK for an SPS multicast transmission that the UE 102 successfully receives and from which the UE 102 obtains a transport block. In cases where the configuration parameters do not include the indication, the UE 102 refrains from transmitting to the DU 174 a HARQ ACK for an SPS multicast transmission that the UE 102 successfully receives and obtains a transport block. In such cases, the UE 102 is only allowed to transmit to the DU 174 a HARQ NACK for an SPS multicast transmission where the UE 102 fails to obtain a transport block.
HARQ ACK indication, which configures the UE 102 to transmit a HARQ ACK for an SPS multicast transmission that the UE 102 successfully receives and from which the UE 102 obtains a transport block. In cases where the configuration parameters do not include the indication, the UE 102 refrains from transmitting to the DU 174 a HARQ ACK for an SPS multicast transmission where the UE 102 successfully obtains a transport block. In such cases, the UE 102 is only allowed to transmit to the DU 174 a HARQ NACK for an SPS multicast transmission where the UE 102 fails to obtain a transport block. In some implementations, the DU 174 can include either one of the HARQ NACK indication, HARQ ACK/NACK indication and HARQ ACK indication.
Aggregation factor, which is the number of repetitions for SPS multicast transmission(s). The DU 174 can transmit (i.e., multicast) a number of repetitions of an SPS multicast transmission in accordance the aggregation factor, and the UE 102 receives the repetitions based on the aggregation factor. In cases where the DU 174 does not include the aggregation factor in the DU configuration, the UE 102 and DU 174 in some implementations can apply an aggregation factor for dynamic scheduling multicast transmission as described above. Alternatively, the UE 102 and DU 174 can apply an aggregation factor for unicast transmission(s). In some implementations, the UE 102 and DU 174 can apply an aggregation factor for unicast transmission(s) as described above.
MCS configuration, which indicates a MCS table that the DU 174 uses to transmit an SPS multicast transmission and the UE 102 uses to receive the SPS multicast transmission. For example, the MCS table can be a MCS table defined in 3GPP specification 38.214 (e.g., a low-SE 64QAM table indicated in Table 5.1.3.1-3 of 3GPP TS 38.214 or a new table specific for multicast transmission). In some implementations, if DU 174 does not include the MCS configuration in the DU configuration, the UE 102 and DU 174 can apply a MCS table predefined in 3GPP specification 38.214. For example, the predefined MCS table can be a 256QAM table or a 64QAM table, e.g., indicated in Table 5.1.3.1-2 or non-low-SE 64QAM table indicated in Table 5.1.3.1-1 of the specification 38.214, respectively. In cases where the DU 174 does not include the MCS configuration in the DU configuration, the UE 102 and DU 174 in other implementations can apply a MCS table for dynamic scheduling multicast transmission to receive SPS multicast transmissions from the DU 174 as described above. Alternatively, the UE 102 and DU 174 can apply a MCS table for unicast transmission to receive SPS multicast transmissions from the DU 174. In some implementations the UE 102 and DU 174 can apply a MCS table for unicast transmission to receive SPS multicast transmissions from the DU 174 as described above. In some implementations, the DU 174 can include, in the DU configuration, a PDSCH configuration (e.g., PDSCH-Config) configuring the MCS table for unicast transmissions. In other implementations, the DU 174 can transmit to the UE 102 another DU configuration including the PDSCH configuration, similar to events 516, 518, and 520.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message or any suitable RRC message that can include a UL NAS PDU.

With continued reference to FIG. 5A, the UE 103 can perform 530 an MBS session join procedure similar to the procedure 502 discussed above. The UE 103 can perform a PDU session establishment procedure with the CN 110 via the base station 104 as described above. The UE 103 can communicate a PDU session ID with the CN 110 in the PDU session establishment procedure. The UE 103 can join a different MBS session from the UE 102 by sending an MBS session join request and specifying a different MBS session ID (e.g., a second MBS session ID).

The CU 172 includes additional transport layer configuration(s) for the additional MBS session(s) to configure additional common DL tunnel(s) in BS-to-CN message(s) in the MBS resource setup and UE-specific MBS session configuration procedure(s), similar to the first or second BS-to-CN message. Each of the transport layer configuration(s) configures a particular common DL tunnel of the common DL tunnel(s) and can be associated to a particular MBS session of the additional MBS session(s). The transport layer configurations can be different to distinguish between different common DL tunnels. In particular, any pair of the transport layer configurations can have different IP addresses, different DL TEIDs, or different IP addresses as well as different DL TEIDs.

The CU 172 and the CN 110 then perform 587 an MBS session resource setup procedure for the second MBS session to establish a second common CN-to-BS DL tunnel and a second common CU-to-DU DL tunnel, similar to the MBS session resource setup procedure 586 for the first MBS session discussed above. The UE 103, the CU 172, and the CN 110 perform 589 a UE-specific MBS session configuration procedure for the second MBS session, similar to the UE-specific MBS session configuration procedure 590 for the first MBS session discussed above. In the procedure 587, the CU 172 can obtain second plural configuration parameters from the DU 174 and transmit an RRC reconfiguration message including the second plural configuration parameters and second MRB configuration(s) to the UE 103. Example implementations of the second plural configuration parameters and second MRB configuration(s) are similar to the first plural configuration parameters and first MRB configuration(s), respectively, as described above.

In the UE-specific MBS session configuration procedure 589 for the second MBS session, the RRC reconfiguration message can include different LCID (value), MRB configuration, and RLC bearer configuration than those in the RRC reconfiguration message of event 520. The RRC reconfiguration message can have a different G-RNTI, LCID and/or RLC bearer configuration, for example.

The CN 110 can then send 532 MBS data for the first MBS session and send 538 MBS data for the second MBS session to the CU 172 via their respective common CN-to-BS DL tunnels. Then the CU 172 sends 534 the MBS data for the first MBS session and sends 540 the MBS data for the second MBS session to the DU 174 via their respective common CU-to-DU DL tunnels. The DU 174 transmits (e.g., multicast or unicast) 536 the MBS data for the second MBS session via one or more logical channels and/or MRB(s) to the UE 103 and transmits (e.g., multicast or unicast) 542 the MBS data for the first MBS session via one or more logical channels and/or MRB(s) to the UE 102, similar to event 528. The UE 102 receives 542 the MBS data for the first MBS session via the one or more logical channels, and the UE 103 receives 536 the MBS data for the second MBS session via the one or more logical channels which may different from the logical channels for the first MBS session, similar to event 528. In some implementations, the DU 174 can transmit 536 the MBS data or MAC PDU(s) including the MBS data via one or more multicast transmissions (e.g., dynamic or SPS multicast transmission(s)) to the UE 103 as described above. In such cases, the UE 103 can receive 536 the MBS data or the MAC PDU(s) via the one or more multicast transmissions from the DU 174 as described above. In some implementations, the DU 174 can transmit 542 the MBS data or MAC PDU(s) including the MBS data via one or more multicast transmissions (e.g., dynamic or SPS multicast transmission(s)) to the UE 102 as described above. In such cases, the UE 102 can receive 542 the MBS data or the MAC PDU(s) via the one or more multicast transmissions from the DU 174 as described above.

FIG. 5B illustrates an example scenario 500B similar to the scenario 500A illustrated in FIG. 5A. In the example scenario 500B, however, the UE 103 joins both a second MBS session (as in the example scenario 500A) and a first MBS session (i.e., the same MBS session joined by the UE 102 in procedure 502) during the same time period. More specifically, the UE 103 can perform 530 an MBS session join procedure for the second MBS session, and can perform 531 an MBS session join procedure for the first MBS session. The base station 104 and the CN 110 then perform 587 an MBS session resource setup procedure for the second MBS session. The UE 103, the base station 104, and the CN 110 perform 589 a UE-specific MBS session configuration procedure for the second MBS session. Furthermore, the UE 103, the base station 104, and the CN perform 591 a UE-specific MBS session configuration procedure for the first MBS session, similar to event 590.

The UE 103 can join the same MBS session as the UE 102 by specifying the same MBS session ID in the MBS session join request (e.g., the first MBS session ID). In the example scenario 500B, the UE 103 joins the first MBS session after the base station 104 has started transmitting 528 MBS data packets for the first MBS session to the UE 102. The CN 110 transmits, to the CU 172, a CN-to-BS message including the MBS session ID and/or the PDU session ID in order to indicate that the UE 103 should start receiving MBS data for the first MBS session corresponding to the first MBS session ID.

The CU 172 or CN 110 determines that a DL tunnel for the first MBS session already exists, and that there is no need to perform the procedure 586. Optionally, however, the CU 172 sends a CU-to-DU message to the DU 174 to request a set-up for an MBS context and/or a common DL tunnel for the first MBS session, and the DU 174 responds with a DU configuration. The CU 172 transmits an RRC reconfiguration message to the UE 103 to configure the UE 103 to receive the MBS traffic for the first MBS session. The RRC reconfiguration message can include the same LCID (value), MRB configuration, and RLC bearer configuration as for the UE 102, when the UEs 102 and 103 operate in the same cell or different cells. When the UEs 102 and 103 operate in different cells, the RRC reconfiguration message can have a different, G-RNTI, LCID and/or RLC bearer configuration, for example. The RRC reconfiguration message can include the same MRB configuration as for the UE 102, when the UEs 102 and 103 operate in different cells. As illustrated in FIG. 3, the CU 172 can map data packets arriving via the common CN-to-BS DL tunnel to one or more MRBs, each corresponding to a common CU-to-DU DL tunnel and/or a respective logical channel. Furthermore, the RRC reconfiguration message can include the same LCID (value), MRB configuration, and RLC bearer configuration for the first MBS session for UE 103 as the LCID (value), MRB configuration, and RLC bearer configuration for the second MBS session for the UE 103. Accordingly, the UE 103 may receive MBS data for the first and second MBS sessions via the same logical channel(s) and/or MRB(s).

In any event, the CN 110 can then send 532, 538 MBS data for the first MBS session and MBS data for the second MBS session to the CU 172. Then the CU 172 sends 534, 540 the MBS data for the first MBS session and the MBS data for the second MBS session to the DU 174. The DU 174 transmits (e.g., multicast or unicast) 536 the MBS data for the second MBS session via one or more logical channels and/or MRB(s) to the UE 103, and transmits (e.g., multicast or unicast) 546 the MBS data for the first MBS session via one or more logical channels and/or MRB(s) to the UE 103. The UE 103 can receive 536 the MBS data for the first MBS session and receives 546 the MBS data for the second MBS session during the same time period, such that the UE 103 can receive two sets of MBS data for different MBS sessions at once. Additionally, the DU 174 transmits (e.g., multicast or unicast) 542 the MBS data for the first MBS session via one or more logical channels and/or MRB(s) to the UE 102. In some implementations, the DU 174 transmits 542 and 546 the MBS data for the first MBS session to the UEs 102 and 103, respectively, via multicast. In other implementations, the DU 174 transmits 542 and 546 the MBS data for the first MBS session to the UEs 102 and 103 separately via unicast.

In some implementations, the CU 172 transmits 544 two instances of the MBS data for the first MBS session to the DU 174. The DU then transmits 542 the first instance of the MBS data for the first MBS session to the UE 102 and transmits 546 the second instance of the MBS data for the first MBS session to the UE 103. In other implementations, the DU 174 receives a single instance of the MBS data for the first MBS session from the CU 172 and transmits the MBS data for the first MBS sessions to each of the UEs that joined the first MBS session.

Next, several example methods that may be implemented by devices illustrated in FIGS. 1A and/or 1B are discussed with reference to FIGS. 6A-8B. It is understood that, for each of FIGS. 6A-8B, different packets can respectively cause a UE and RAN node (i.e., a base station) implementing the depicted method to follow different pathways shown in the figures in different instances (e.g., at different times). Each of these methods can be implemented as a set of instructions stored on a non-transitory computer-readable medium and executable by one or more processors and/or can be implemented by processing hardware.

Generally speaking, the methods allow a UE to reliably receive MBS data packet(s) by way of a HARQ process. In a HARQ process, the RAN node can transmit an MBS data packet to the UE, and in response, the UE can transmit HARQ feedback (e.g., HARQ negative acknowledgement (NACK) to indicate the MBS data packet was not successfully received, or HARQ acknowledgement (ACK) to indicate the MBS data packet was successfully received) to the RAN node. In turn, the RAN node can either retransmit the MBS data packet (when the HARQ feedback is HARQ NACK) or transmit a new MBS data packet (when the HARQ feedback is HARQ ACK).

In some scenarios, during a HARQ process, the RAN node can transmit an MBS data packet to the UE via multicast (i.e., an MBS multicast transmission or simply “multicast transmission”), and after receiving HARQ feedback from the UE, retransmit the MBS data packet or transmit a new MBS data packet via unicast (i.e., an MBS unicast transmission or simply “unicast transmission”). As such, the HARQ process can be considered to be “shared” or “mixed” when used to deliver both a multicast transmission and a unicast transmission to the UE in the same HARQ process (i.e., respective DCIs that are transmitted to the UE to prepare the UE for receiving a multicast transmission and a unicast transmission include the same HARQ process number). However, in some cases, the UE may not support PTP retransmission, and thus unable to receive a unicast transmission as a unicast retransmission. The RAN node can take the UE capability of receiving PTP retransmission into account, in some implementations.

In some scenarios, the RAN node need not consider whether the UE supports PTP retransmission at all when performing a HARQ process. In one such scenario, the RAN can send a multicast transmission to the UE, and after receiving a HARQ NACK from the UE, re-sends the MBS data packet via multicast (i.e., a multicast retransmission). In another such scenario, the RAN can send an MBS data packet via unicast (i.e., a unicast transmission), and after receiving a HARQ NACK from the UE, re-sends the MBS data packet via unicast (i.e., a unicast retransmission). As such, because the RAN node maintains either the multicast or unicast throughout the HARQ process, the HARQ process in these scenarios is not considered to be shared or mixed.

Turning now to FIGS. 6A-6E, these figures generally illustrate various methods in which the UE attempts to receive a first transmission that includes an MBS data packet and a subsequent second transmission in accordance with a HARQ process, and further determines whether the second transmission is a new transmission or a retransmission of the first transmission. FIGS. 6A-6C illustrate the UE considering whether it supports or enables PTP retransmission to make the determination. FIG. 6D illustrates the UE comparing transport block sizes of the first transmission and the second transmission to make the determination. FIG. 6E illustrates the UE determining which RNTI was used to receive the second transmission to make the determination.

Referring first to FIG. 6A, a UE (e.g., UE 102, UE 103) can implement method 600A to receive MBS data packet(s) from a RAN (e.g., DU 174, CU 172, or base station 104) via multicast and unicast in a shared HARQ process.

Preliminarily, at block 602, the UE optionally transmits, to the RAN node, a UE capability indicating that the UE does not support PTP retransmission for MBS. When the UE does not support PTP retransmission for MBS, the UE does not support receiving a retransmission of the same MBS data packet that was undelivered previously from the RAN node. In some implementations, when the UE does not support PTP retransmission for MBS, the UE does not support receiving a unicast HARQ retransmission of the same MBS data packet that was undelivered previously from the RAN node in a multicast HARQ transmission.

At block 604, in preparation for receiving MBS data packet(s) using a HARQ process, the UE receives, from the RAN node, a first DCI with a CRC (i.e., a CRC of the first DCI) scrambled by G-RNTI for scheduling a multicast transmission, where the first DCI includes a first HARQ process number and a first New Data Indicator (NDI) value. The first HARQ process number identifies the HARQ process, and the NDI specifies whether the first DCI is for a new transmission (i.e., a new HARQ transmission that has not been previously transmitted to the UE) carrying MBS data packet(s), or a retransmission (i.e., a HARQ retransmission) carrying the previous undelivered MBS data packet(s).

At block 606, the UE determines whether the multicast transmission is a new transmission or a retransmission in accordance with the first HARQ process number and the first NDI value.

At block 608, the UE receives and processes the multicast transmission in accordance with the first DCI and the determination made at block 606 (see, e.g., events 528, 536, 542).

At 610, the UE transmits a first HARQ feedback to the RAN node, to indicate whether it successfully received and processed the multicast transmission. The first HARQ feedback can be a HARQ NACK to indicate that the multicast transmission was not successfully received, or a HARQ ACK to indicate that the multicast transmission was successfully received.

At block 612, in preparation for receiving MBS data packet(s) using the same HARQ process, the UE receives, from the RAN node, a second DCI with a CRC (i.e., a CRC of the second DCI) scrambled by a C-RNTI (i.e., a C-RNTI of the UE) for scheduling a unicast transmission, where the second DCI includes the first HARQ process number (thus indicating the same HARQ process) and a second NDI value. Like the first NDI value, the second NDI value specifies whether the second DCI is for a new transmission (carrying new MBS data packet(s)), or a retransmission (carrying the previous undelivered MBS data packet(s)). In some implementations, the first and second NDI values can be the same or different.

In implementations in which the RAN node receives, from the UE (e.g., in block 602) or from another entity (e.g., CN 110), the UE capability indicating that the UE does not support PTP retransmission, the RAN node determines that the UE does not support PTP retransmission for MBS and in response, refrains from sending any DCI that would otherwise be used for scheduling a unicast HARQ retransmission for the UE.

At block 614, the UE determines the unicast transmission as a new transmission irrespective of the second NDI value. In some implementations, the UE ignores the second NDI value, and upon determining that the first HARQ process number included in the second DCI is the same as that included in the first DCI, determines that the unicast transmission is a new transmission.

Then, at block 616, the UE receives the unicast transmission in accordance with the second DCI and the determination made at block 614.

At block 618, the UE transmits a second HARQ feedback to the RAN node, to indicate whether it successfully received and processed the unicast transmission. The second HARQ feedback can be a HARQ NACK to indicate that the unicast transmission was not successfully received, or a HARQ ACK to indicate that the unicast transmission was successfully received.

In some implementations, the UE assigns a HARQ process associated with the first HARQ process number to receive the multicast transmission and the unicast transmission. In some implementations, the UE transmits the first HARQ feedback in accordance with a first configuration (e.g., PUCCH configuration or HARQ ACK/NACK configuration) and transmits the second HARQ feedback in accordance with a second configuration (e.g., PUCCH configuration or HARQ ACK/NACK configuration). In other implementations, the UE transmits the first HARQ feedback and second HARQ feedback in accordance with a configuration (e.g., PUCCH configuration or HARQ ACK/NACK configuration).

In some implementations, the first DCI can include a field indicating a particular uplink carrier or a particular cell for the first HARQ feedback, e.g., in accordance with the first configuration. The UE transmits the first HARQ feedback on the particular carrier or the particular cell in accordance with the indication in the field. In other implementations, the first DCI does not include a field indicating a particular uplink carrier or a particular cell for the first HARQ feedback. In such cases, the UE transmits the first HARQ feedback on a predetermined uplink carrier (e.g., primary component carrier) or a predetermined cell (e.g., primary cell), e.g., in accordance with the first configuration. In some implementations, the second DCI can include a field indicating a particular uplink carrier or a particular cell for the second HARQ feedback, e.g., in accordance with the second configuration. In such cases, the UE transmits the second HARQ feedback on the particular carrier or particular cell. In other implementations, the second DCI does not include a field indicating a particular uplink carrier or a particular cell for the second HARQ feedback. In such cases, the UE transmits the second HARQ feedback on a predetermined uplink carrier (e.g., primary component carrier) or a predetermined cell (e.g., primary cell), e.g., in accordance with the second configuration.

If the UE determines that the first NDI value is toggled compared to an NDI value in a DCI received before the first DCI that addressing the HARQ process, the UE at block 606 determines that the multicast transmission is a new transmission. In response to determining that the multicast transmission is a new transmission, the UE obtains a transport block from the multicast transmission. For example, the UE decodes data (i.e., channel coded bits) in the multicast transmission to obtain the transport block. In some implementations, the UE flushes a soft buffer associated with the HARQ process to receive the multicast transmission in response to determining that the multicast transmission is a new transmission. If the UE determines that the first NDI value is not toggled compared to the NDI value mentioned above, the UE at block 606 determines that the multicast transmission is a retransmission. In response to determining that the multicast transmission is a retransmission, the UE combines data (i.e., channel coded bits) in the multicast transmission with data (i.e., channel coded bits) currently in the soft buffer and decodes the combined data to obtain a transport block. In cases where the UE successfully obtains a MAC PDU from the transport block or verifies that a CRC of the transport block is valid, the UE provides the first HARQ feedback as a HARQ ACK. In cases where the UE fails to obtain a MAC PDU from the transport block or verifies that the CRC of the transport block is invalid, the UE provides the first HARQ feedback as a HARQ NACK.

In some implementations, in response to determining that the unicast transmission is a new transmission, the UE obtains a second transport block from the unicast transmission. In some implementations, the UE flushes the soft buffer associated with the HARQ process to receive the unicast transmission in response to determining that the unicast transmission is a new transmission. In cases where the UE successfully obtains a MAC PDU from the second transport block or verifies that a CRC of the second transport block is valid, the UE provides the second HARQ feedback as a HARQ ACK. In cases where the UE fails to obtain a MAC PDU from the second transport block or verifies that the CRC of the second transport block is invalid, the UE provides the second HARQ feedback as a HARQ NACK.

In some implementations for block 602, the UE can transmit a first RRC message (e.g., UECapabilityInformation message) including the UE capability to the RAN node. In some implementations, the UE can transmit the first RRC message to the RAN node in response to receiving a second RRC message (e.g., a UECapabilityEnquiry message) from the RAN node. In some implementations, the UE capability can be a UE-NR-Capability IE. In one implementation, the UE capability can include an indication indicating PTP retransmission for MBS is unsupported. In another implementation, the UE capability can exclude an indication indicating PTP retransmission for MBS is supported. In some implementations, the UE capability can indicate that the UE supports PTM transmission for MBS, i.e., the UE is capable of receiving MBS via PTM transmission (i.e., multicast transmission, including HARQ new transmission and HARQ retransmission, scheduled by a G-RNTI). More specifically, the UE capability includes an MBS PTM indication indicating support of PTM transmission for MBS. In implementations where the UE supports PTM transmission, the UE can by default support PTM retransmission without explicitly indicating that the UE supports PTM retransmission in the UE capability. Alternatively, the UE capability can include an indication indicating that the UE supports PTM retransmission.

In some implementations of block 602, the UE can transmit to a CN (e.g., CN 110) a first NAS message including a UE capability ID identifying the UE capability which has been stored in the CN, or a network node from which the CN can receive the UE capability. In such cases, the CN transmits an interface message including the UE capability to the RAN node. For example, the interface message can be a NG application protocol (NGAP) message defined in 3GPP specification 38.413. In any event, after receiving the UE capability from the UE or the CN, the RAN is aware of whether the UE is capable of receiving PTP retransmissions and/or PTM transmissions.

FIG. 6B illustrates an example method 600B similar to method 600A, except that the UE of method 600B supports PTP retransmission. As such, in method 600B, the UE at block 603 optionally transmits, to the RAN node, a UE capability indicating support for PTP retransmission. In other implementations, as described above with respect to FIG. 6A, the RAN node receives the UE capability indirectly from the UE, via a CN (e.g., CN 110) communicatively coupled to the RAN node. Also as described above with respect to FIG. 6A, the UE capability can indicate that the UE supports PTM transmission for MBS. In some implementations, the UE supporting the PTM transmission for MBS is mandated to support the PTP retransmission. In such cases, the UE can indirectly indicate support of the PTP retransmission in the UE capability by including the explicit MBS PTM indication in the UE capability. In such cases, the MBS PTM indication indicates that the UE supports both PTM transmission and PTP retransmission.

The method 600B proceeds to blocks 604, 606, 608, 610, and 612, similar to method 600A of FIG. 6A. In implementations in which the RAN node receives, from the UE (e.g., in block 603) or from another entity (e.g., CN 110), the UE capability indicating that the UE supports PTP retransmission, the RAN node determines that the UE supports PTP retransmission, and in response, sends a DCI (e.g., the second DCI of block 612) for scheduling a HARQ retransmission including MBS data for the UE.

Whereas the UE of FIG. 6A at block 614 determines that the unicast transmission is a new transmission irrespective of the second NDI value included in the second DCI at block 612, the UE of FIG. 6B at block 615 determines whether the unicast transmission is a new transmission or a retransmission in accordance with the second NDI value.

If the UE determines that the second NDI value is toggled compared to the first NDI value, the UE at block 615 determines that the unicast transmission is a new transmission. In response to determining that the unicast transmission is a new transmission, the UE obtains a transport block from the unicast transmission. For example, the UE decodes data (i.e., channel coded bits) in the unicast transmission to obtain the transport block. In some implementations, the UE flushes the soft buffer associated with the HARQ process to receive the unicast transmission in response to determining that the unicast transmission is a new transmission.

If the UE determines that the second NDI value is not toggled compared to the first NDI value, the UE at block 615 determines that the unicast transmission is a retransmission. In response to determining that the unicast transmission is a retransmission, the UE combines data (i.e., channel coded bits in the unicast transmission) with data (i.e., channel coded bits) currently in the soft buffer (e.g., including the channel coded bits in the multicast transmission) and decodes the combined data to obtain a transport block.

In cases where the UE successfully obtains a MAC PDU from the transport block or verifies that a CRC of the transport block is valid, the UE provides the second HARQ feedback as a HARQ ACK. In cases where the UE fails to obtain a MAC PDU from the transport block or verifies that the CRC of the transport block is invalid, the UE provides the second HARQ feedback as a HARQ NACK.

FIG. 6C illustrates an example method 600C similar to methods 600A and 600B, except that the UE of method 600C determines whether the unicast transmission is a new transmission or a retransmission based on whether PTP retransmission has been enabled.

The method 600C begins at block 604, and proceeds to blocks 606, 608, 610, and 612, similar to methods 600A and 600B. In response to receiving the second DCI, the UE at block 613 determines whether PTP retransmission for MBS is enabled. If the UE determines that the PTP retransmission is not enabled, method 600C proceeds to block 614 as described above in FIG. 6A. Otherwise (i.e., if the UE determines that the PTP retransmission is enabled), method 600C proceeds to the block 615 as described above in FIG. 6B.

In some implementations, the UE enables PTP retransmission if the UE supports PTP retransmission, and the UE disables PTP retransmission if the UE does not support PTP retransmission. In some implementations, the UE stores a flag in a non-volatile memory or a Universal Subscriber Identity Module (USIM). In cases where the flag indicates PTP retransmission is enabled, the UE indicates that the UE supports PTP retransmission in the UE capability. In cases where the flag indicates PTP retransmission is disabled, the UE indicates that the UE does not support PTP retransmission in the UE capability. In some implementations, the UE enables PTP retransmission if the RAN node configures the UE to enable PTP retransmission. For example, the UE receives a RRC reconfiguration message configuring PTP retransmission from the RAN node. In some implementations, the RAN node can configure the UE to enable the PTP retransmission, if the RAN node receives a UE capability indicating that the UE supports the PTP retransmission, as described above in blocks 602 and 603. In other implementations, the UE disables PTP retransmission if the RAN node does not configure the UE to enable PTP retransmission. In some implementations, the RAN node refrains from configuring the UE to enable PTP retransmission, if the RAN node receives a UE capability indicating that the UE does not support PTP retransmission. In other implementations, the RAN refrains from configuring the UE to enable PTP retransmission because the RAN node does not support PTP retransmission.

FIG. 6D illustrates an example method 600D similar to 600B, except whereas the UE of method 600B determines whether a unicast transmission is a new transmission or a retransmission of the previously undelivered multicast transmission in accordance with the second NDI value, the UE of method 600D performs the determination based on whether the unicast transmission has the same transport block size as the previously undelivered multicast transmission.

The method 600D begins optionally at block 603, and proceeds to blocks 604, 606, 608, and 610, similar to method 600B. Subsequently, whereas the UE of method 600B at block 612 receives a second DCI that includes the first HARQ process number and the second NDI value, the UE of method 600D at block 622 receives a second DCI that includes the first HARQ process number and the same first NDI value included in the first DCI of block 604.

At block 623, the UE compares the transport block indicated in the first DCI of block 604 with the transport block indicated in the second DCI of block 622. When the UE determines that the transport block sizes are not the same, method 600D proceeds to block 624, where the UE determines that the unicast transmission is a new transmission. In such cases, the UE ignores the first NDI value. Otherwise, when the UE determines that the transport block sizes are the same, method 600D proceeds to block 625, where the UE determines that the unicast transmission is a retransmission.

FIG. 6E illustrates an example method 600E similar to method 600A, except whereas the UE of method 600A uses a C-RNTI to receive and determine that a unicast transmission is a new transmission, the UE of method 600E determines which RNTI (e.g., C-RNTI or G-RNTI) the UE used to determine whether a HARQ transmission from the RAN node is a new transmission or a retransmission.

The method 600E begins optionally at block 602, and proceeds to blocks 604, 606, 608, and 610, similar to method 600A. At block 611, in preparation for receiving a subsequent HARQ transmission from the RAN node, the UE receives a second DCI with a scrambled CRC, where the second DCI includes the first HARQ process number and a second NDI value.

At block 633, the UE verifies that the scrambled CRC is valid by using either a C-RNTI of the UE or a G-RNTI. If at block 633 the UE used a C-RNTI to verify that the scrambled CRC of block 611 is valid, the UE at block 634 determines that the subsequent transmission is a new transmission (i.e., a new unicast transmission) irrespective of the second NDI value. If at block 633 the UE used a G-RNTI to verify that the scrambled CRC of block 611 is valid, the UE at block 635 determines that the subsequent transmission is either a new transmission (i.e., a new multicast transmission) or a retransmission (i.e., a multicast retransmission) in accordance with the second NDI value.

Based on the determination at block 634 or block 635, the UE at block 636 receives and process the subsequent transmission in accordance with the second DCI. At block 638, the UE transmits a second HARQ feedback for the subsequent transmission to the RAN node. To some extent, blocks 634, 636, 638 are similar to blocks 614, 616, and 618 of FIG. 6A, respectively, and block 635 is similar to block 615 of FIG. 6B.

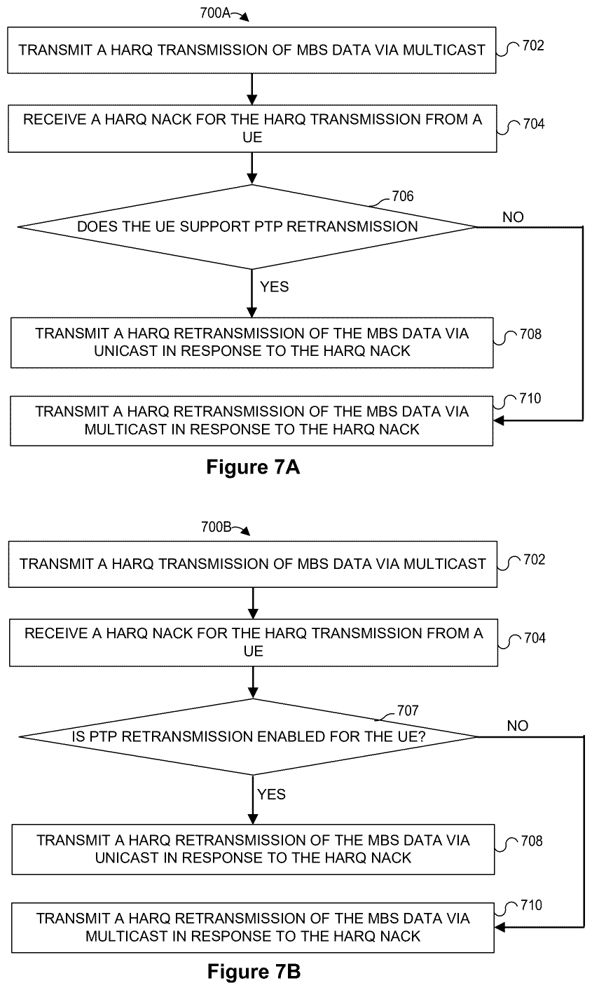

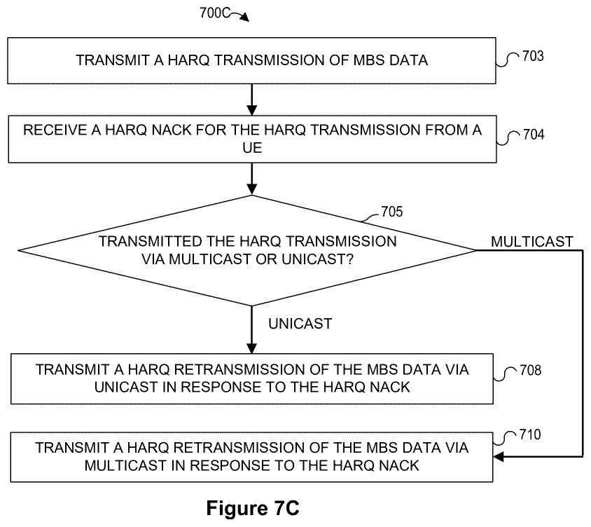

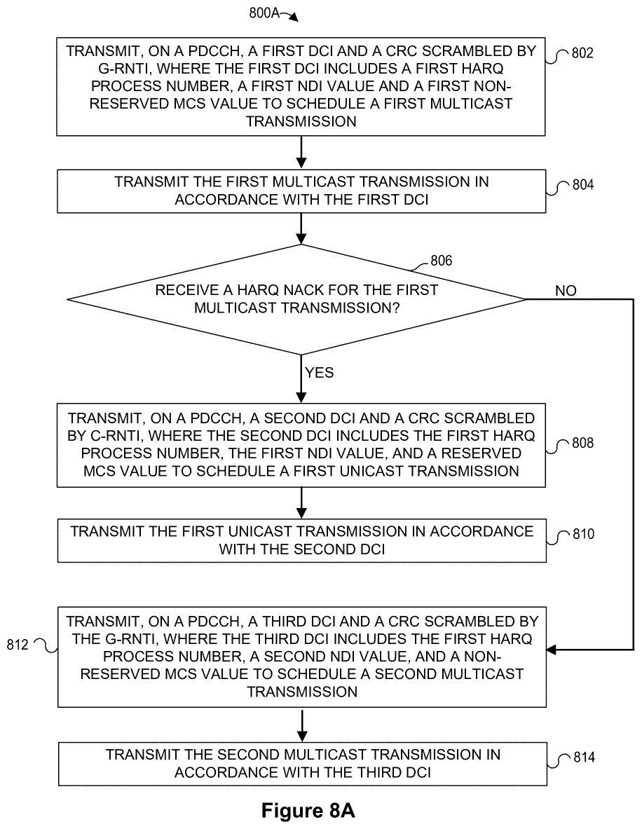

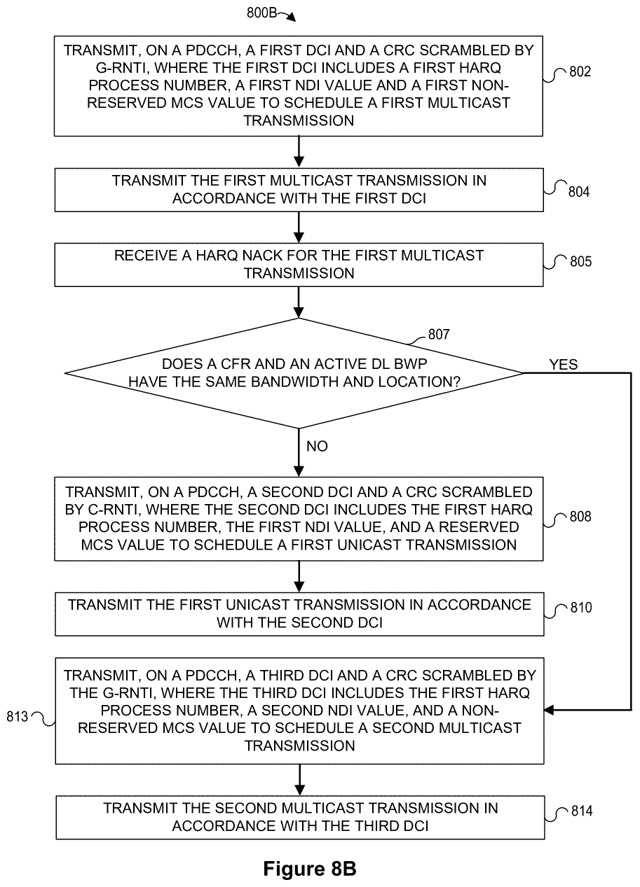

Turning now to FIGS. 7A-7C and 8A-8B, these figures generally illustrate various methods in which the RAN node sends a first transmission that includes an MBS data packet, and determines whether to send a subsequent second transmission via multicast or unicast in accordance with a HARQ process. FIGS. 7A-7B illustrate the RAN node considering whether the UE supports or enables PTP retransmission to make the determination. FIG. 7C illustrates the RAN node considering whether the first transmission was transmitted via multicast or unicast to make the determination. FIG. 8A illustrates the RAN node considering a HARQ feedback for the first transmission received from the UE to make the determination. FIG. 8B illustrates the RAN node considering network bandwidth conditions associated with the first transmission to make the determination.

Referring first to FIG. 7A, a RAN node (e.g., base station 104 or DU 174) can implement a method 700A to transmit MBS data packet(s) to a UE (e.g., UE 102, UE 103) via multicast and unicast. Generally, the RAN node of FIG. 7A determines, in response to receiving a HARQ NACK from the UE, how (e.g., via multicast or unicast) to transmit a subsequent HARQ transmission based on whether the UE supports PTP retransmission.

The method 700A begins at block 702, where the RAN node transmits a HARQ transmission of MBS data via multicast (see e.g., event 528, 536, 542). In some implementations, the HARQ transmission can be a new HARQ transmission or a HARQ retransmission.

At block 704, the RAN node receives, from a UE, a HARQ NACK for the HARQ transmission.

At block 706, the RAN node determines whether the UE supports PTP retransmission (e.g., based on the UE capability described above). If the RAN node determines that the UE supports PTP retransmission, the RAN node at block 708 transmits a HARQ retransmission of the MBS data via unicast to the UE in response to the HARQ NACK (see e.g., event 528, 536, 542). Otherwise, if the RAN node determines that the UE does not support PTP retransmission, the RAN node at block 710 transmits a HARQ retransmission of the MBS data via multicast in response to the HARQ NACK.

In some implementations, the RAN node at block 702 transmits the HARQ transmission via the multicast using a HARQ process. In such cases, the RAN node can configure the HARQ process for multicast transmission. Later in time, the RAN node determines to use the HARQ process for unicast transmission for the UE, e.g., because the MBS is inactive or the UE stops receiving the MBS. In response to the determination, the RAN node determines to reconfigure the HARQ process for unicast transmission. In response to reconfiguring the HARQ process for unicast transmission, the RAN node toggles an NDI of the HARQ process. After reconfiguring the HARQ process, the RAN node determines to transmit a unicast transmission to the UE using the HARQ process. In response to the determination, the RAN node transmits to the UE a DCI which includes the toggled NDI and a HARQ process number of the HARQ process. The RAN node generates a CRC of the DCI, scrambles the CRC with a C-RNTI of the UE, and transmits the DCI and scrambled CRC to the UE on a PDCCH.

FIG. 7B illustrates an example method 700B similar to the method 700A, except the RAN node of FIG. 7B determines how to transmit the subsequent HARQ transmission based on whether the UE enabled PTP retransmission. For example, and as described above with respect to FIG. 6C, if the RAN node transmitted to the UE an RRC reconfiguration message to configure or enable PTP retransmission, the RAN node at block 707 determines that PTP retransmission is enabled for the UE, and proceeds to block 708. As another example, if the RAN node receives a UE capability indicating that the UE does not support PTP retransmission, the RAN node refrains from configuring the UE to enable PTP retransmission at block 707, and proceeds to block 710.

FIG. 7C illustrates an example method 700C similar to the method 700A or method 700B, except the RAN node of FIG. 7C omits considerations related to whether the UE supports or enables PTP retransmission. Instead, the RAN node of FIG. 7C determines how (e.g., via multicast or unicast) to transmit a subsequent HARQ transmission based on how (e.g., via multicast or unicast) the previous HARQ transmission was transmitted.

At block 703, the RAN node transmits a HARQ transmission. Thus, at block 705, the RAN node determines whether the HARQ transmission is transmitted via unicast or multicast.

At block 704, the RAN node receives a HARQ NACK from the UE. If the RAN node transmitted the HARQ transmission via unicast at block 705, the RAN node at block 708 transmits a HARQ retransmission via unicast in response to the HARQ NACK. On the other hand, if the RAN node transmitted the HARQ transmission via multicast at block 705, the RAN node at block 710 transmits a HARQ retransmission via multicast in response to the HARQ NACK.

Referring next to FIG. 8A, a RAN node (e.g., base station 104 or DU 174) can implement a method 800A to transmit MBS data packet(s) to a UE (e.g., UE 102, UE 103) via multicast and unicast.

The method 800A begins at block 802, where the RAN node transmits to the UE, on a PDCCH, a first DCI and a CRC (i.e., a CRC of the DCI) scrambled by a G-RNTI to schedule a first (new) multicast transmission of a first MBS data packet for the UE. The first DCI includes a first HARQ process number, a first NDI value, and a first non-reserved MCS value (e.g., first I_{MCS} value).

At block 804, the RAN node transmits the first multicast transmission in accordance with the first DCI. Consequently, at block 806, the RAN node attempts to receive, from the UE, a HARQ feedback for the first multicast transmission.

If the RAN node at block 806 receives a HARQ NACK for the first multicast transmission, the RAN node at block 808 transmits to the UE, on a PDCCH, a second DCI and a CRC scrambled by a C-RNTI of the UE to schedule a first unicast transmission (i.e., a retransmission of the first MBS data packet) for the UE. The second DCI includes the first HARQ process number, the first NDI value, and a reserved MCS value. At block 810, the RAN node then transmits the first unicast transmission in accordance with the second DCI. Although not shown, in some implementations, the RAN node receives from the UE a HARQ NACK for the first unicast transmission. In response, the RAN node can transmit, on a PDCCH, a fourth DCI and a CRC scrambled by the C-RNTI of the UE to schedule a second unicast transmission (i.e., a retransmission of the first MBS data packet) for the UE. The fourth DCI includes the first HARQ process number, the first NDI value, and a reserved MCS value. The reserved MCS value in the fourth DCI can be the same as or different from the reserved MCS value in the second DCI. The RAN node then transmits the second unicast transmission in accordance with the fourth DCI.

On the other hand, if the RAN node at block 806 does not receive a HARQ NACK for the first multicast transmission, the RAN node at block 812 transmits to the UE, on a PDCCH, a third DCI with CRC (i.e., a CRC of the third DCI) scrambled by a G-RNTI to schedule a second multicast transmission (i.e., a new transmission of a second MBS data packet). The second DCI includes the first HARQ process number, a second NDI value, and a non-reserved MCS value (e.g., second I_{MCS} value). At block 814, the RAN node then transmits the second multicast transmission in accordance with the third DCI.

In some implementations, the RAN node at block 808 can alternatively transmit, on a PDCCH, a fifth DCI and a CRC scrambled by the G-RNTI, to schedule a third multicast transmission (i.e., a retransmission of the first MBS data). The fifth DCI includes the first HARQ process number, the first NDI value, and a reserved MCS value. The RAN node can do so if the UE does not support PTP retransmission or the RAN node does not enable PTP retransmission for the UE.

FIG. 8B illustrates an example method 800B similar to the method 800A, except the RAN node of FIG. 8B determines how to transmit either the first unicast transmission or the second multicast transmission based on network bandwidth conditions associated with the first multicast transmission.

The method 800B begins at block 802, and proceeds to block 804, similar to method 800A.

At block 805, the RAN node receives from the UE a HARQ NACK for the first multicast transmission.

At block 807, the RAN node determines network bandwidth conditions associated with the first multicast transmission. In some implementations, the RAN node determines whether a common frequency resource (CFR) over which the RAN node and UE perform the HARQ process has the same configuration (e.g., same bandwidth and location of a configuration resource like a PRB) as an active DL BWP for the UE. If the RAN node at block 807 determines that the CFR and the active DL BWP have the same configuration, the RAN node transmits the second multicast transmission as a multicast retransmission at block 813. This is in contrast to the RAN node of method 800A, where the RAN node transmits the second multicast transmission as a new transmission at block 812. Then the RAN node proceeds to block 814, similar to method 800A. In some implementations or scenarios, the RAN node configures the CFR and the active DL BWP to share exactly the same spectrum because the RAN node has limited spectrum. In such cases, the RAN node can dynamically assign radio resources for MBS and unicast services. However, this also increases complexity in managing radio resources for MBS and unicast services.

On the other hand, if the RAN node at block 807 determines that the CFR and the active DL BWP have different configurations (e.g., do not have the same bandwidth and location of a configuration resource like PRBs), the RAN node thus transmits the first unicast transmission as a unicast retransmission at block 808 to increase the likelihood that the UE receives the first unicast transmission, similar to the RAN node of method 800A. Then the RAN node proceeds to block 810, similar to method 800A. In such cases, the RAN node can assign radio resources for MBS and radio resources for unicast services on the CFR and active DL BWP separately.

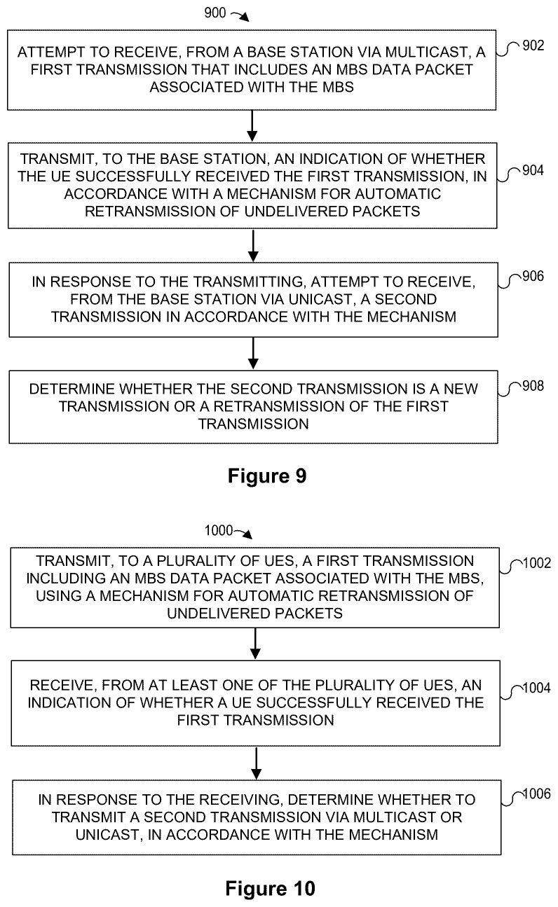

Referring now to FIG. 9, an example method 900 can be implemented in a UE (e.g., UE 102 or UE 103) for receiving MBS from a base station (e.g., base station 104, DU 174).

At block 902, a UE attempts to receive, from a base station via multicast, a first transmission that includes an MBS data packet associated with the MBS (e.g., in events or blocks 528, 536, 542, 604, 606, 608).

At block 904, the UE transmits, to the base station, an indication of whether the UE successfully received the first transmission, in accordance with a mechanism for automatic retransmission of undelivered packets (e.g., in block 610).

At block 906, in response, the UE attempts to receive, from the base station via unicast, a second transmission in accordance with the mechanism (e.g., in events 528, 536, 542, 612, 616, 622, 636).

At block 908, the UE determines whether the second transmission is a new transmission or a retransmission of the first transmission (e.g., in blocks 614, 615, 624, 625, 634, 635).

Referring now to FIG. 10, an example method 1000 can be implemented in a base station (e.g., base station 104, DU 174) for providing MBS to a UE (e.g., UE 102, UE 103).

At block 1002, a base station transmits, to a plurality of UEs, a first transmission including an MBS data packet associated with the MBS, using a mechanism for automatic retransmission of undelivered packets (e.g., in events 528, 536, 542, 702, 703, 804).

At block 1004, the base station receives, from at least one of the plurality of UEs, an indication of whether a UE successfully received the first transmission (e.g., in blocks 704, 805, 806).

At block 1006, in response, the base station determines whether to transmit a second transmission via multicast or unicast, in accordance with the mechanism (e.g., in events 528, 536, 542, 708, 710, 810, 814).

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”. In some implementations, “SPS multicast” can be replaced by “multicast SPS”. Similarly, “dynamic scheduling multicast” can be replaced by “multicast dynamic”. In some implementations, “identifier” can be replaced by “identity”. In some implementations, “CFR” is used and can be replaced by “MBS BWP”.

A user device in which the techniques of this disclosure can be implemented (e.g., the UE 102A, 102B, or UE 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for performing a HARQ process to transmit MBS data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a user equipment (UE) for receiving a multicast and/or broadcast service (MBS), the method comprising:
transmitting, by the UE and to a radio access network (RAN), an indication that the UE supports point-to-point (PTP) retransmission;
receiving, by the UE and from the RAN, a first downlink control information (DCI) scrambled with a group radio network temporary identifier (G-RNTI), the first DCI including a first data indicator (NDI) value;
attempting to receive, by the UE and from the RAN via multicast, a first transmission that includes an MBS data packet associated with the MBS in accordance with the first NDI value;
receiving, by the UE and from the RAN, a second DCI scrambled with a cell radio network temporary identifier (C-RNTI), the second DCI including a second NDI value; and
determining, by the UE and based on the first NDI value and the second NDI value, that the second DCI is associated with a new transmission of another MBS data packet associated with the MBS.

2-20. (canceled)

21. The method of claim 1, wherein the indication that the UE supports PTP retransmission includes an indication that the UE supports PTP retransmission for the MBS.

22. The method of claim 1, wherein each of the first DCI and the second DCI includes a same process number in accordance with a mechanism for automatic retransmission of undelivered packets, and the determining that the second DCI is associated with the new transmission of the other MBS data packet associated with the MBS is further based on the same process number.

23. The method of claim 22, further comprising transmitting, by the UE and to the RAN, an indication of whether the UE successfully received the first transmission, in accordance with the mechanism for the automatic retransmission of undelivered packets.

24. The method of claim 1, wherein the receiving of the second DCI scrambled with the C-RNTI is based on the transmitting of the indication that the UE supports the PTP retransmission.

25. The method of claim 1, wherein the determining that the second DCI is associated with the new transmission of the other data packet associated with the MBS includes determining that the first NDI value and the second NDI value are not equivalent.

26. The method of claim 1, further comprising:
responsive to the determining, attempting to receive, by the UE and from the RAN via unicast, the new transmission of the other MBS data packet associated with the MBS in accordance with the second NDI value.

27. The method of claim 1, wherein the MBS data packet is a first MBS data packet, the MBS is a first MBS, the G-RNTI is a first G-RNTI, the C-RNTI is a first C-RNTI, and the method further comprises:
receiving, by the UE and from the RAN, a third DCI scrambled with a second G-RNTI, the third DCI including a third NDI value;
attempting to receive, by the UE and from the RAN via multicast, a second transmission that includes a second MBS data packet associated with a second MBS in accordance with the third NDI value;
receiving, by the UE and from the RAN, a fourth DCI scrambled with a second C-RNTI, the fourth DCI including a fourth NDI value; and
determining, by the UE and based on the third NDI value and the fourth NDI value, whether the fourth DCI is associated with a PTP retransmission of the second MBS data packet associated with the second MBS or with a new transmission of a further MBS data packet associated with the second MBS.

28. The method of claim 27, wherein:
each of the first DCI and the second DCI includes a first process number in accordance with a mechanism for automatic retransmission of undelivered packets;
each of the third DCI and the fourth DCI includes a second process number in accordance with the mechanism for the automatic retransmission of undelivered packets; and
the determining of whether the fourth DCI is associated with the PTP retransmission of the second MBS data packet or the new transmission of the further MBS data packet is further based on the second process number.

29. The method of claim 27, further comprising transmitting, by the UE and to the RAN, an indication of whether the UE successfully received the second transmission, in accordance with the mechanism for the automatic retransmission of undelivered packets.

30. The method of claim 29, wherein the receiving of the fourth DCI is responsive to the transmitting of the indication of whether the UE successfully received the second transmission.

31. The method of claim 27, wherein determining whether the fourth DCI is associated with the PTP retransmission of the second MBS data packet or with the new transmission of the further MBS data packet includes:
determining that the fourth DCI is associated with the PTP retransmission of second MBS data packet when the third NDI is equivalent to the fourth NDI; and
determining that the fourth DCI is associated with the new transmission of the further MBS data packet when the third NDI and the fourth NDI are not equivalent.

32. The method of claim 27, further comprising:
determining that the fourth DCI is associated with the PTP retransmission of the second MBS data packet; and
attempting to receive the PTP retransmission of the second MBS data packet in accordance with the third NDI value.

33. The method of claim 27, further comprising:
determining that the fourth DCI is associated with the new transmission of the further MBS data packet; and
responsive to the determining, attempting to receive, by the UE and from the RAN via unicast, the new transmission of the further MBS data packet in accordance with the fourth NDI value.

34. A UE comprising processing hardware and configured to implement the method of claim 1.
